(19) United States
(12) Patent Application Publication
(10) Pub. No.: US 2021/0345134 A1
(43) Pub. Date: Nov. 4, 2021

(54) HANDLING OF MACHINE LEARNING TO IMPROVE PERFORMANCE OF A WIRELESS COMMUNICATIONS NETWORK

(71) Applicant: Telefonaktiebolaget LM Ericsson (publ), Stockholm (SE)

(72) Inventors: Johan OTTERSTEN, Stockholm (SE); Hugo TULLBERG, Nyköping (SE)

(21) Appl. No.: 17/286,287

(22) PCT Filed: Oct. 19, 2018
(86) PCT No.: PCT/SE2018/051069

§ 371 Date: Apr. 16, 2021

(51) Int. Cl. H04W 24/02; H04W 24/08; G06N 20/00; G06N 5/04

(52) U.S. Cl. CPC H04W 24/02; G06N 5/04; G06N 20/00; H04W 24/08

(57) ABSTRACT

A wireless communications system and a method therein for handling of machine learning. The system includes a central node and one or more intermediate nodes arranged between the central node and one or more leaf nodes. Further, at least one out of the nodes includes a machine learning unit. The system determines, by means of the machine learning unit and a machine learning model relating to at least one node out of the one or more intermediate nodes or the one or more leaf nodes, a prediction of a performance of the at least one node based on input data relating to the at least one node. Further, the system performs, based on the determined prediction, an operation relating to the at least one node, and communicates the determined prediction and/or information relating to the machine learning model to one or more other nodes.

### TECHNICAL FIELD

Embodiments herein relate generally to a wireless communications system, a network node, a machine learning unit and to methods therein. In particular, embodiments relate to handling of machine learning to improve the performance of a wireless communications network comprised in the communications system.

### BACKGROUND

In a typical wireless communication network, communications devices, also known as wireless communication devices, wireless devices, mobile stations, stations (STA) and/or User Equipments (UEs), communicate via a Local Area Network such as a WiFi network or a Radio Access Network (RAN) to one or more Core Networks (CN). The RAN covers a geographical area which is divided into service areas or cell areas, which may also be referred to as a beam or a beam group, with each service area or cell area being served by a Radio Network Node (RNN) such as a radio access node e.g., a Wi-Fi access point or a Radio Base Station (RBS), which in some networks may also be denoted, for example, a NodeB, eNodeB (eNB), or gNB as denoted in 5G. A service area or cell area is an area, e.g. a geographical area, where radio coverage is provided by the radio network node. The radio network node communicates over an air interface operating on radio frequencies with the communications device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques used in Advanced Antenna Systems (AAS) can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO systems.

Machine Learning (ML) will become an important part of current and future wireless communications networks and systems. In this disclosure the terms machine learning and ML may be used interchangeably. Recently, machine learning has been used in many different communication applications and shown great potential. As ML becomes increasingly utilized and integrated in the communications system, a structured architecture is needed for communicating ML information between different nodes operating in the communications system. Some examples of such nodes are wireless devices, radio network nodes, core network nodes, computer cloud nodes just to give some examples. Usage of the communications system and the realization of the communications system, including the radio communication interface, the network architecture, interfaces and protocols will change when Machine Intelligence (MI) capabilities are ubiquitously available to all types of nodes in and end-users of a communication system. In this disclosure the terms machine intelligence and MI may be used interchangeably. The communications system needs to be capable of handling data-driven solutions. Initiatives are currently being taken to install software on Base Stations (BSs) to extract data from operators as well as extracting data from other nodes operating in the communications system. These efforts show how important it will be to have communications systems that are able to handle data-oriented solutions in future systems. A communication system where Machine Intelligence capabilities are ubiquitously available to all types of nodes in and end-users of the communication system is envisioned.

When used in this disclosure, the term “interfaces” refer to physical and/or logical points where different units in the communication system interacts, e.g., the radio interface/air interface, where a UE and an eNB exchange information via radio waves. Different units in the network may exchange information via cable or fibre. Further, the term “protocol” when used in this disclosure refers to an agreed method to exchange information, e.g. between entities at the same level in a system. It's a set of rules for what information should be exchanged when. With Machine Intelligence, the network nodes may become free to redefine the protocols depending on the situation and environment.

In general, the term Artificial Intelligence (AI) comprises reasoning, knowledge representation, planning, learning, natural language processing, perception and the ability to move and manipulate objects. Hence Machine Learning (ML) is sometimes considered as a subfield of AI. In this disclosure, the term Machine Intelligence (MI) is used to comprise both AI and ML. Further, in this disclosure the terms AI, MI and ML may be used interchangeably.

The machine intelligence should not be considered as an additional layer on top of the communication system, but rather the opposite—the communication in the communications system takes place to allow distribution of the machine intelligence. The end-user, e.g. a wireless device, should interact with a distributed machine intelligence to achieve whatever it is the wireless device wants to achieve. The wireless device may have access to different ML models for different purposes. For example, one purpose may be to predict relevant information about a communication link to reduce the need for measurements and therefore decreasing complexity and overhead in the communications system comprising the communication link.

### SUMMARY

As part of developing embodiments herein, some drawbacks with the state of the art communications system will first be identified and discussed.

Future wireless communications systems will comprise more data-driven solutions where technologies, such as machine learning technologies, will be powerful tools in many different applications. Data driven solution in communications is currently being investigated and will be a key feature in the future wireless communications systems. Currently, the needed types and amounts of data are not available to machine learning models, and more information needs to be extracted from the communication system and used in the right way to improve the communications system and build truly data-driven systems and solutions. An architecture and protocol for handling machine learning integrated in the wireless communication network does not exist.

Therefore, a machine learning architecture for data driven communication networks and systems, and solutions to provide ubiquitous distributed machine intelligence are provided. Distributed storage and compute power is included—ever-present, but not infinite. Some embodiments disclosed herein relate to an architecture and protocols for handling machine learning in the communications system. Further, embodiments disclosed herein provide a structured solution which will enable easy communication between different machine learning models both horizontally and vertically in the wireless communications network.

According to developments of wireless communications systems an improved usage of resources in the wireless communications system is needed for improving the performance of the wireless communications system.

Therefore, an object of embodiments herein is to overcome the above-mentioned drawbacks among others and to improve the performance in a wireless communications system.

According to an aspect of embodiments herein, the object is achieved by a method performed in a wireless communications system for handling of machine learning to improve performance of a wireless communications network operating in the wireless communications system. The wireless communications system comprises a central network node and one or more intermediate network nodes arranged between the central network node and one or more leaf network operating in the wireless communications network. At least one out of: the central network node, the one or more intermediate network nodes or the one or more leaf network nodes comprises a machine learning unit.

The wireless communications system determines, by means of the machine learning unit and a machine learning model relating to at least one network node out of the one or more intermediate network nodes or the one or more leaf network nodes, a prediction of a performance of the at least one network node based on input data relating to the at least one network node.

Further, the wireless communications system performs, based on the determined prediction, one or more operations relating to the at least one network node and transmits the determined prediction and/or information relating to the machine learning model to one or more other network nodes.

According to another aspect of embodiments herein, the object is achieved by a wireless communications system for handling of machine learning to improve performance of a wireless communications network configured to operate in the wireless communications system. The wireless communications system is configured to comprise a central network node and one or more intermediate network nodes arranged between the central network node and one or more leaf network operating in the wireless communications network. At least one out of: the central network node, the one or more intermediate network nodes or the one or more leaf network nodes is configured to comprise a machine learning unit.

The wireless communications system is configured to determine, by means of the machine learning unit and a machine learning model relating to at least one network node out of the one or more intermediate network nodes or the one or more leaf network nodes, a prediction of a performance of the at least one network node based on input data relating to the at least one network node.

Further, the wireless communications system is configured to perform, based on the determined prediction, one or more operations relating to the at least one network node and configured to transmit the determined prediction and/or information relating to the machine learning model to one or more other network nodes.

According to another aspect of embodiments herein, the object is achieved by a method performed in a network node for handling of machine learning to improve performance of a wireless communications network operating in a wireless communications system. The wireless communications system comprises a central network node and one or more intermediate network nodes arranged between the central network node and one or more leaf network nodes operating in the wireless communications network. The network node is any one out of the central network node, the one or more intermediate network node, or the one or more leaf network nodes. Further, the network node comprises a machine learning unit.

The network node determines, by means of the machine learning unit and a machine learning model relating to at least one network node out of the one or more intermediate network nodes or the one or more leaf network nodes, a prediction of a performance of the at least one network node based on input data relating to the at least one network node.

Further, the network node performs, based on the determined prediction, one or more operations relating to the at least one network node, and transmits the determined prediction and/or information relating to the machine learning model to one or more other network nodes.

According to another aspect of embodiments herein, the object is achieved by a network node for handling of machine learning to improve performance of a wireless communications network operating in a wireless communications system. The wireless communications system is configured to comprise a central network node and one or more intermediate network nodes arranged between the central network node and one or more leaf network nodes operating in the wireless communications network. The network node is any one out of the central network node, the one or more intermediate network node, or the one or more leaf network nodes. Further, the network node is configured to comprise a machine learning unit.

The network node is configured to determine, by means of the machine learning unit and a machine learning model relating to at least one network node out of the one or more intermediate network nodes or the one or more leaf network nodes, a prediction of a performance of the at least one network node based on input data relating to the at least one network node.

Further, the network node is configured to perform, based on the determined prediction, one or more operations relating to the at least one network node, and to transmit the determined prediction and/or information relating to the machine learning model to one or more other network nodes.

According to another aspect of embodiments herein, the object is achieved by a method performed in a machine learning unit for handling of machine learning to improve performance of a wireless communications network operating in a wireless communications system. The wireless communications system comprises a central network node and one or more intermediate network nodes arranged between the central network node and one or more leaf network nodes operating in the wireless communications network. At least one out of: the central network node, the one or more intermediate network nodes or the one or more leaf network nodes comprises the machine learning unit.

The machine learning unit determines, by means of a machine learning model relating to at least one network node out of the one or more intermediate network nodes or the one or more leaf network nodes and based on input data relating to the at least one network node, a prediction of a performance of the at least one network node.

According to another aspect of embodiments herein, the object is achieved by a machine learning unit for handling of machine learning to improve performance of a wireless communications network configured to operate in a wireless communications system. The wireless communications system is configured to comprise a central network node and one or more intermediate network nodes arranged between the central network node and one or more leaf network nodes operating in the wireless communications network. At least one out of: the central network node, the one or more intermediate network nodes or the one or more leaf network nodes is configured to comprise the machine learning unit.

The machine learning unit is configured to determine, by means of a machine learning model relating to at least one network node out of the one or more intermediate network nodes or the one or more leaf network nodes and based on input data relating to the at least one network node, a prediction of a performance of the at least one network node.

According to another aspect of embodiments herein, the object is achieved by a computer program, comprising instructions which, when executed on at least one processor, causes the at least one processor to carry out the method performed by the wireless communications system.

According to another aspect of embodiments herein, the object is achieved by a computer program, comprising instructions which, when executed on at least one processor, causes the at least one processor to carry out the method performed by the network node.

According to another aspect of embodiments herein, the object is achieved by a computer program, comprising instructions which, when executed on at least one processor, causes the at least one processor to carry out the method performed by the machine learning unit.

According to another aspect of embodiments herein, the object is achieved by a carrier comprising the computer program, wherein the carrier is one of an electronic signal, an optical signal, a radio signal or a computer readable storage medium.

Since the prediction of the performance of the at least one network node based on input data relating to the at least one network node is determined, since one or more operations relating to the at least one network node is performed and since the determined prediction and/or information relating to the machine learning model is transmitted to one or more other network nodes, the one or more other network nodes will receive knowledge about the network environment without the need of performing measurements and/or operations itself in order to obtain this information and thus the signalling in the wireless communications network will be reduced. Therefore, a more efficient use of the radio spectrum is provided. This results in an improved performance in the wireless communications system.

An advantage with embodiments herein is that machine intelligence capabilities are provided to all types of network nodes operating in and users of the wireless communications system. Thereby, one or more network nodes operating in the communications system may use information related to machine learning possibly transmitted from other network nodes to improve performance.

A further advantage with embodiments herein is that the prediction of useful information about the propagation environment of a network node in the communications network provide reduced network complexity, reduced overhead and delay in the communications network as compared to prior art wireless communications system.

A yet further advantage with embodiments herein is that they provide flexibility to use different machine learning models at different network nodes.

### BRIEF DESCRIPTION OF DRAWINGS

Examples of embodiments herein will be described in more detail with reference to attached drawings in which:

FIG. 1 is a schematic block diagram illustrating embodiments of a wireless communications system;

FIG. 2A is a schematic block diagram illustrating embodiments of a centralized, cloud-based learning architecture;

FIG. 2B is a schematic exemplary diagram illustrating two partially overlapping clusters with two cluster heads communicating with a high-layer machine learning model;

FIG. 3 is a flowchart depicting embodiments of a method performed by a wireless communications system;

FIG. 4A is a flowchart depicting embodiments of a method performed by a network node;

FIG. 4B is a schematic block diagram illustrating embodiments of a network node;

FIG. 5A is a flowchart depicting embodiments of a method performed by a machine learning unit;

FIG. 5B is a schematic block diagram illustrating embodiments of a machine learning unit;

FIG. 6 is a combined flowchart and signalling scheme schematically illustrating embodiments of a method performed in a wireless communications system;

FIG. 7 is a combined flowchart and signalling scheme schematically illustrating embodiments of a method performed in a wireless communications system;

FIG. 8 schematically illustrates training of several machine learning models at one site;

FIG. 9 is a flowchart depicting embodiments of a prediction procedure.

FIG. 10 is a flowchart depicting embodiments of a prediction procedure; and

FIGS. 11 to 16 are flowcharts illustrating methods implemented in a communication system including a host computer, a base station and a user equipment.

### DETAILED DESCRIPTION

Throughout the following description similar reference numerals may be used to denote similar elements, units, modules, circuits, nodes, parts, items or features, when applicable. In the Figures, features that appear only in some embodiments are typically indicated by dashed lines.

In the following, embodiments herein are illustrated by exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

According to embodiments herein, it is provided a way of improving the performance in the wireless communications system by e.g. improving usage of resources in the wireless communications system. However, even if some embodiments described herein relate to improved resource utilization it should be understood that some embodiments disclosed herein, alternatively or additionally, may provide an improved flexibility and/or an improved adaptability.

In order to overcome the above-mentioned drawbacks, some embodiments disclosed herein are based on extracting information, e.g. data, from the communications system in order to train site-specific machine learning models that are used to predict useful information about the network environment, e.g. propagation environment, relating to a network node operating in the wireless communications system. Different access points, e.g. different network nodes, may have different network environments, e.g. different propagation environments. Machine learning models for different purposes may be trained in for example a central network node or in an intermediate network node. The central network node may be a cloud network node comprised in a cloud network.

In addition to communication-related data, some embodiments disclosed herein also describe how machine learning models support different user needs. It should be understood that the term “user” should not be limited to a human user, but the term may refer to a communications device operated by a user or an Internet of Things (IoT) device. For example, a human Mobile Broad Band (MBB) user and an IoT device may have very different needs and expectations on the wireless communication network.

By the use of extra signalling, information about the model type, e.g. the type of the machine learning model, and a prediction of a performance of a network node may be exchanged between the wireless device, different network nodes, and the cloud network node. The prediction of the performance may for example be which modulation and coding scheme (MCS) to use, which transmitter beam and receiver beam to use, and user traffic needs, just to give some examples. Thus, the determined prediction may for example be efficient utilization of radio resources, or scheduling of users, or user movement patterns. Some examples of types of machine learning models are neural networks, decision trees, and random forests such as multiple trees trained slightly different to reduce sensitivity, and the performance may be mean squared error, cross-entropy, or classification accuracy, just to give some examples. The signalling may be performed via a series of distributed, intermediate network nodes. A cloud-based solution may manage many different machine learning models and information, e.g. data, from the wireless device. For example, the location of the wireless device may be used to determine which of the machine learning models to use for the relevant predictions. Refined and reinforcement learning may be used to continuously update the one or more machine learning models based on new inputs. This provides flexibility if something in the network environment changes.

By the expression “refined learning” when used in this disclosure is meant any way to update a machine learning model, e.g. a current machine learning model, using new data received during operations. One way to achieve this is through reinforcement learning. By the expression “reinforcement learning” when used in this disclosure is meant how the machine learning unit, e.g. a software agent, takes actions in an environment and updates its behaviour as to maximize some notion of cumulative reward. In a communication system the reward is related to some performance metric. By the expression “refined and reinforcement learning” when used in this disclosure is meant refinement of the machine learning model, e.g. the current machine learning model, possibly using reinforcement learning.

Further, by the expression “network environment” when used in this disclosure is meant e.g. a communication environment of a network node such as a propagation environment, e.g. a set of radio channels available, but it may also refer to the number of users, and/or the traffic demands of a user.

Disclosed herein are examples of a machine learning architecture and protocols for data-driven solutions in a wireless communications system. Exemplifying detailed implementations are also described.

Especially, some embodiments disclosed herein relate to a machine learning architecture and protocol for data driven solutions to help improve future wireless communications systems and provide integration of AI in the RAN.

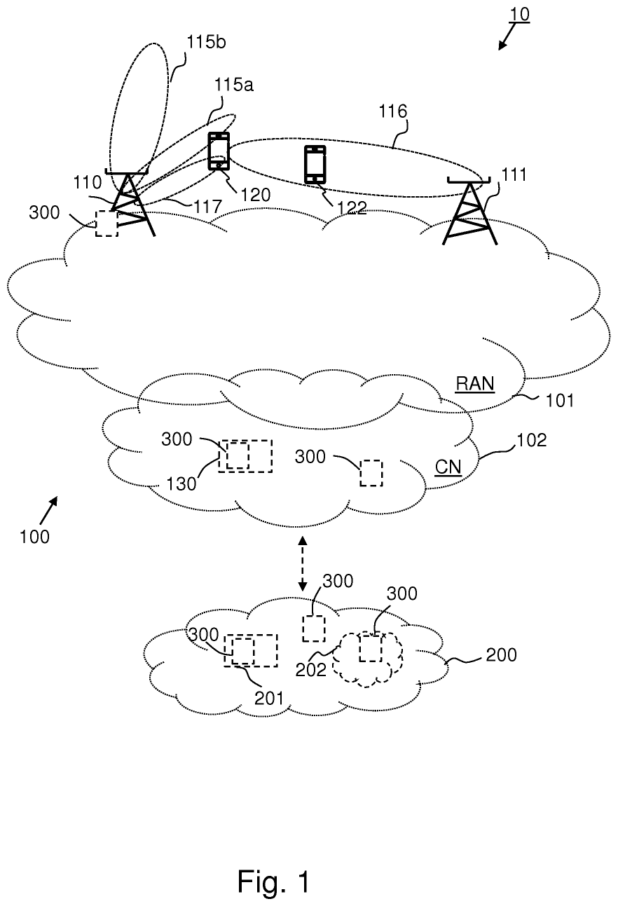

FIG. 1 is a schematic block diagram schematically depicting an example of a wireless communications system 10 that is relevant for embodiments herein and in which embodiments herein may be implemented.

A wireless communications network 100 is comprised in the wireless communications system 10. The wireless communications network 100 may comprise a Radio Access Network (RAN) 101 part and a Core Network (CN) 102 part. The wireless communication network 100 is typically a telecommunication network, such as a cellular communication network that supports at least one Radio Access Technology (RAT), e.g. New Radio (NR) that also may be referred to as 5G. The RAN 101 is sometimes in this disclosure referred to as an intelligent RAN (iRAN). By the expression “intelligent RAN (IRAN)” when used in this disclosure is meant a RAN comprising and/or providing machine intelligence, e.g. by means of a device that perceives its environment and takes actions that maximize its chance of successfully achieving its goals. The machine intelligence may be provided by means of a machine learning unit as will be described below. Thus, the iRAN is a RAN that e.g. has the AI capabilities described in this disclosure.

The wireless communication network 100 comprises network nodes that are communicatively interconnected. The network nodes may be logical and/or physical and are located in one or more physical devices. The wireless communication network 100 comprises one or more network nodes, e.g. a radio network node 110, such as a first radio network node, and a second radio network node 111. A radio network node is a network node typically comprised in a RAN, such as the RAN 101, and/or that is or comprises a radio transmitting network node, such as a base station, and/or that is or comprises a controlling node that controls one or more radio transmitting network nodes.

The wireless communication network 100, or specifically one or more network nodes thereof, e.g. the first radio network node 110 and the second radio network node 111, may be configured to serve and/or control and/or manage and/or communicate with one or more communication devices, such as a wireless device 120, using one or more beams, e.g. a downlink beam 115a and/or a downlink beam 115b and/or a downlink beam 116 provided by the wireless communication network 100, e.g. the first radio network node 110 and/or the second radio network node 111, for communication with said one or more communication devices. Said one or more communication devices may provide uplink beams, respectively, e.g. the wireless device 120 may provide an uplink beam 117 for communication with the wireless communication network 100.

Each beam may be associated with a particular Radio Access Technology (RAT). As should be recognized by the skilled person, a beam is associated with a more dynamic and relatively narrow and directional radio coverage compared to a conventional cell that is typically omnidirectional and/or provides more static radio coverage. A beam is typically formed and/or generated by beamforming and/or is dynamically adapted based on one or more recipients of the beam, such as one of more characteristics of the recipients, e.g. based on which direction a recipient is located. For example, the downlink beam 115a may be provided based on where the wireless device 120 is located and the uplink beam 117 may be provided based on where the first radio network node 110 is located.

The wireless device 120 may be a mobile station, a non-access point (non-AP) STA, a STA, a user equipment and/or a wireless terminals, an Internet of Things (IoT) device, a Narrow band IoT (NB-IoT) device, an eMTC device, a CAT-M device, an MBB device, a WiFi device, an LTE device and an NR device communicate via one or more Access Networks (AN), e.g. RAN, to one or more core networks (CN). It should be understood by the skilled in the art that “wireless device” is a non-limiting term which means any terminal, wireless communication terminal, user equipment, Device to Device (D2D) terminal, or node e.g. smart phone, laptop, mobile phone, sensor, relay, mobile tablets or even a small base station communicating within a cell.

Moreover, the wireless communication network 100 may comprise one or more central nodes, e.g. a central node 130 i.e. one or more network nodes that are common or central and communicatively connected to multiple other nodes, e.g. multiple radio network nodes, and may be configured for managing and/or controlling these nodes. The central nodes may e.g. be core network nodes, i.e. network nodes part of the CN 102.

The wireless communication network, e.g. the CN 102, may further be communicatively connected to, and thereby e.g. provide access for said communication devices, to an external network 200, e.g. the Internet. The wireless device 120 may thus communicate via the wireless communication network 100, with the external network 200, or rather with one or more other devices, e.g. servers and/or other communication devices connected to other wireless communication networks, and that are connected with access to the external network 200.

Moreover, there may be one or more external nodes, e.g. an external node 201, for communication with the wireless communication network 100 and node(s) thereof. The external node 201 may e.g. be an external management node. Such external node may be comprised in the external network 200 or may be separate from this.

Furthermore, the one or more external nodes may correspond to or be comprised in a so called computer, or computing, cloud, that also may be referred to as a cloud system of servers or computers, or simply be named a cloud, such as a computer cloud 203, for providing certain service(s) to outside the cloud via a communication interface. In such embodiments, the external node may be referred to as a cloud node or cloud network node 202. The exact configuration of nodes etc. comprised in the cloud in order to provide said service(s) may not be known outside the cloud. The name “cloud” is often explained as a metaphor relating to that the actual device(s) or network element(s) providing the services are typically invisible for a user of the provided service(s), such as if obscured by a cloud. The computer cloud 203, or typically rather one or more nodes thereof, may be communicatively connected to the wireless communication network 100, or certain nodes thereof, and may be providing one or more services that e.g. may provide, or facilitate, certain functions or functionality of the wireless communication network 100 and may e.g. be involved in performing one or more actions according to embodiments herein. The computer cloud 203 may be comprised in the external network 200 or may be separate from this.

One or more higher layers of the communications network and corresponding protocols are well suited for cloud implementation. By the expression higher layer when used in this disclosure is meant an OSI layer, such as an application layer, a presentation layer or a session layer. The central layers, e.g. the higher levels, of the iRAN architecture are assumed to have wide or global reach and thus expected to be implemented in the cloud.

One advantage of a cloud implementation is that data may be shared between different machine learning models, e.g. between machine learning models for different communications links. This may allow for a faster training mode by establishing a common model based on all available input. During a prediction mode, separate machine learning models may be used for each site or communications link. The machine learning model corresponding to a particular site or communications link may be updated based on data, such as ACK/NACK, from that site. Thereby, machine learning models optimized to the specific characteristic of the site are obtained.

By the term “site” when used in this disclosure is meant a location of a device radio network node, e.g. the first and/or the second radio network node 110,111.

One or more machine learning units 300 are comprised in the wireless communications system 10. Thus, it should be understood that the machine learning unit 300 may be comprised in the wireless communications network 100 and/or in the external network 200. For example, the machine learning unit 300 may be a separate unit operating within the wireless communications network 100 and/or the external network 200 and/or it may be comprised in a node operating within the wireless communications network 100 and/or the external network 200. In some embodiments, a machine learning unit 300 is comprised in the radio network node 110. Additionally or alternatively, the machine learning unit 300 may be comprised in the core network 102, such as e.g. in the central node 130, or it may be comprised in the external node 201 or in the computer cloud 202 of the external network 200.

Attention is drawn to that FIG. 1 is only schematic and for exemplifying purpose and that not everything shown in the figure may be required for all embodiments herein, as should be evident to the skilled person. Also, a wireless communication network or networks that in reality correspond(s) to the wireless communication network 100 will typically comprise several further network nodes, such as core network nodes, e.g. base stations, radio network nodes, further beams, and/or cells etc., as realized by the skilled person, but which are not shown herein for the sake of simplifying.

Note that actions described in this disclosure may be taken in any suitable order and/or be carried out fully or partly overlapping in time when this is possible and suitable. Dotted lines attempt to illustrate features that may not be present in all embodiments.

Any of the actions below may when suitable fully or partly involve and/or be initiated and/or be triggered by another, e.g. external, entity or entities, such as device and/or system, than what is indicated below to carry out the actions. Such initiation may e.g. be triggered by said another entity in response to a request from e.g. the device and/or the wireless communication network, and/or in response to some event resulting from program code executing in said another entity or entities. Said another entity or entities may correspond to or be comprised in a so called computer cloud, or simply cloud, and/or communication with said another entity or entities may be accomplished by means of one or more cloud services.

In this disclosure examples of an architecture for network machine learning and of communications protocols for network machine learning will be described.

For example, a physical and logical architecture for initial development of an intelligent network will be described. The intelligent network may sometimes be referred to as a smart network or a cognitive network or an (iRAN). The physical architecture involves network nodes with sufficient computational, storage and communication capabilities for some level of machine learning, and sufficient to contribute to the overall network intelligence. Pure sensors may be considered a part of the iRAN, or as separate units only providing inputs or stimuli to the iRAN. It may be required that a network node operating in the iRAN is able to host a digital twin, e.g. a possibly limited digital twin.

A Digital Twin or Intelligent Agent (IA) refers to a digital replica of physical users or assets (physical twins), processes and systems that may be used for various purposes. In this setting the digital twin represents its physical twin within the iRAN, and acts on behalf of its physical twin towards achieving its goals.

The digital twin holds the necessary objective function(s) and other functionality to represent its user, e.g. the wireless device, in the iRAN and participates in resource negotiation in the interest of the user, e.g. the wireless device. It transforms data into knowledge and acts to maximize a long-term benefit. For example, in resource negotiations for radio link access, digital twins with different objectives need to negotiate to achieve some optimal or acceptable agreement on resource distributions.

Though not necessary, a hierarchical structure may be used, wherein computational capabilities and storage capabilities are provided higher in more central/higher nodes. Thus, a computer centre, cloud or a cloud node has more capabilities than a wireless device/UE. The number of hierarchy levels is not fixed, and may comprise one or a few global levels, one or more cluster levels, one or more local levels comprising for example eNBs such as a gNodeB, and one or more levels comprising wireless devices, e.g. UEs.

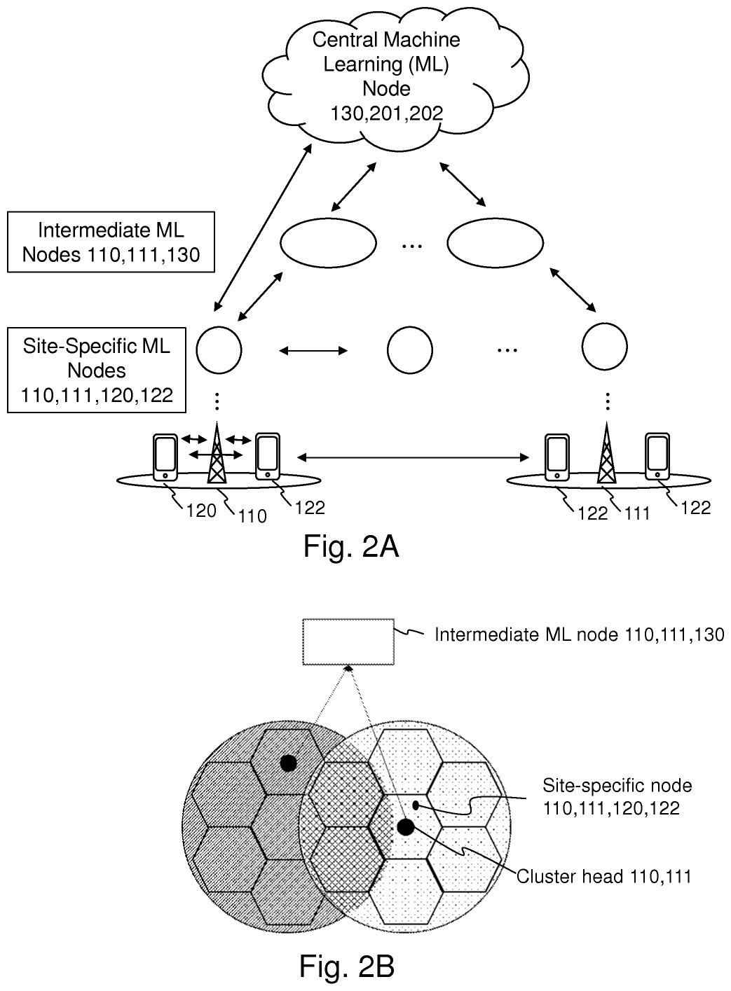

FIG. 2A is a schematic block diagram illustrating embodiments of a centralized, cloud-based learning architecture. In FIG. 2A the architecture is hierarchical, but it should be understood that the architecture does not have to be hierarchical and that it may be peer-to-peer. Thus, it may be a distributed architecture that partitions tasks or workloads between peers. FIG. 2A shows a central machine learning node 130, 201, 202 capable of training and storing machine learning models. Depending on the architecture, the central machine learning node may be the central network node 130, the external network node 201 or the cloud network node 202. Further, FIG. 2A also shows several distributed, intermediate network nodes 110, 111, 130 illustrated in circles and ovals. These intermediate network nodes are capable of training and storing machine learning models as well. These intermediate network nodes comprising one or more machine learning models are sometimes referred to as intermediate machine learning (ML) nodes. Depending on the architecture, the intermediate network nodes 110, 111, 130 may be one or more radio network nodes, e.g. a first radio network node 110 and a second radio network node 111, and the central network node 130.

It should be understood that the number of both vertically and horizontally distributed network nodes is not fixed. Thereby, a form of distributed intelligence in the communications system 10 is provided. The lowest level in FIG. 2A represents the site-specific network nodes 110, 111, 120, 122 which may comprise one or more machine learning models. These nodes are sometimes referred to as site-specific ML nodes. Depending on the architecture, the site-specific network nodes 110, 111, 120, 122 may be one or more radio network nodes, e.g. a first and a second radio network node 110, 112, and one or more wireless devices, e.g. a first wireless device 120 and a second wireless device 122.

Further, one or more lower levels of learning models may be comprised in for example wireless devices, e.g. UEs. These lower levels of machine learning models may be specific for the wireless device, e.g. the UE. The nodes of the lowest level of network nodes are sometimes in this disclosure referred to as leaf network nodes. The leaf nodes may thus be one or more wireless devices 120, 122.

It should be understood that several different machine learning models for different purposes may be stored at each network node. The arrows in FIG. 2A illustrate the different ways to communicate information, e.g. data such as measurement data, between the network nodes. There are many different levels of communications between nodes both horizontally and vertically. A number of different parameters and information about the machine learning model may be exchanged between the network nodes. The exchange of this type of information may aid in for example training, combining machine learning models, and relevant identification of cross-site features for different purpose models. Vertically, partial and/or site-specific machine learning models may be passed upwards to be combined into a more general machine learning model, and/or predictions may be passed. Horizontally, links between machine learning models at the same hierarchical level may be used to e.g., pass training data, partial models and/or predictions between the network nodes at the same hierarchical level.

It should be understood that also the machine learning models may form a hierarchical structure, where lower-level, e.g. more local, machine learning models comprise site-specific details, and higher-level, e.g. clustered and/or global, machine learning models are more aggregated. At each level, a suitable machine learning model may be used to optimize the performance. By the expression “suitable machine learning model” is meant a machine learning that have adequate learning capabilities given the computation and storage capabilities of the node where it resides.

As previously described, FIG. 2A shows a global network node 130, 201, 202, e.g. a central or centralized network node, for training and storing of at least one machine learning model. When possible, depending on e.g. load and traffic in the communications network, the intermediate network nodes 110, 111, 130, may propagate information, e.g. data such as measurement data and information relating to the machine learning model, to the global network node 130, 201, 202. This makes the intelligent system robust against node failures, at which node failures the information otherwise may be lost.

In this disclosure the terms global network node, central network node, centralized network node may be used interchangeable.

As previously mentioned and depending on the network architecture, the central network node may be the core network node 130, the external node 201 or a cloud network node 202. The one or more intermediate network nodes may be the first radio network node 110, the second radio network node 111, and/or the core network node 130. Further, the site-specific network node may be the first radio network node 110, the second radio network node 111, the first communications device 120, and/or the second communications device 122.

FIG. 2B is a schematic exemplary diagram illustrating two partially overlapping clusters with two cluster heads, e.g. the first radio network node 110 and the second radio network node 111, communicating with a node, e.g. an intermediate node or a central node, such as the core network node 130, comprising a high-layer machine learning model. In FIG. 2B, the first radio network node 110 or the second radio network node 111 is the cluster head communicating with an intermediate node 110, 111, 130. Further, one or more site specific nodes, such as one or more wireless devices 120, 122 or another radio network node are operating in the cluster and communicating with the cluster head.

When considering clustering for learning, cf. stacking, the objective is to learn to distinguish between general knowledge and specific knowledge, e.g., site-specific propagation environment. It is likely that it is beneficial to avoid using inputs from outlier models in the general knowledge, but it may be needed to keep track of them for more specific, lower level models. The clustering may be done in different ways. For example, the clustering may be based on geography, e.g. near neighbours may be clustered together. As another example, the clustering may be logical based on e.g., environment, traffic type, user needs.

Communication within a cluster may be either pairwise resulting in a complete graph of connections between peers, or the communication may start with a cluster-head, or other varieties. The clustering may also allow for partial overlap of clusters, e.g., geographically. An example of two partially overlapping clusters with cluster heads communicating with a higher-layer model node is shown in FIG. 2B. The higher-layer model node may for example be seen as one of the intermediate nodes shown in FIG. 1.

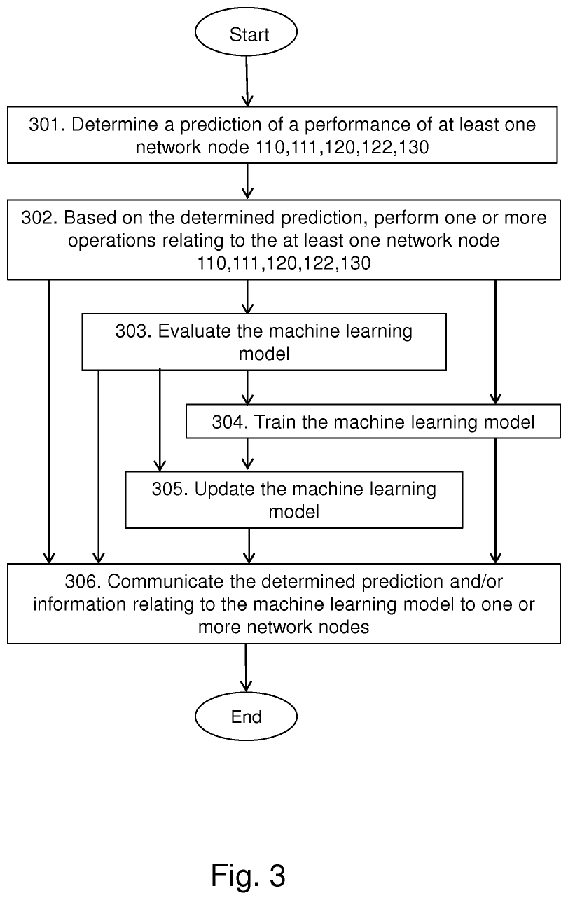

Examples of a method performed by the wireless communications system 10 for handling of machine learning to improve performance of the wireless communications network 100 operating in the wireless communications system 10 will now be described with reference to flowchart depicted in FIG. 3. The wireless communications system 10 comprises a central network node 130, 201, 202 and one or more intermediate network nodes 110, 111, 130 arranged between the central network node 130, 201, 202 and one or more leaf network nodes 120, 122 operating in the wireless communications network 100. Further, at least one out of: the central network node 130, 201, 202, the one or more intermediate network nodes 110, 111, 130 or the one or more leaf network nodes 120, 122 comprises a machine learning unit 300.

As previously mentioned, depending on the network architecture, the central network node may be the core network node 130, the external node 201 or a cloud network node 202. The one or more intermediate network nodes may be the first radio network node 110, the second radio network node 111, and/or the core network node 130. Further, the site-specific network node may be the first radio network node 110, the second radio network node 111, the first communications device 120, and/or the second communications device 122.

As also previously mentioned, the one or more intermediate network nodes 110, 111, 130 may be distributed nodes. Further, the nodes 110, 111, 120, 122, 130, 201, 202 may be arranged in a hierarchical network structure.

The method comprises one or more of the following actions. It should be understood that these actions may be taken in any suitable order and that some actions may be combined.

Action 301

In order to improve performance of the wireless communications network 100, a prediction of a performance of at least one network node 110, 111, 120, 122, 130 operating in the communications network 100 is determined. The prediction of the performance is a prediction of a future performance of the at least one network node 110, 111, 120, 122, 130. The prediction of the performance may for example be which modulation and coding scheme (MCS) to use, which transmitter beam and receiver beam to use, and user traffic needs, just to give some examples. Thus, the determined prediction of performance may for example be efficient utilization of radio resources, or scheduling of users, or user movement patterns.

In Action 301, the wireless communications system 10 determines, by means of the machine learning unit 300 and a machine learning model relating to at least one network node 110, 111, 120, 122, 130 out of the one or more intermediate network nodes 110, 111, 130 or the one or more leaf network nodes 120, 122, a prediction of a performance of the at least one network node 110, 111, 120, 122, 130 based on input data relating to the at least one network node 110, 111, 120, 122, 130. In other words, the machine learning model relates to one or more of the network nodes 110, 110, 120, 122, 130. A machine learning model relating to a network node means a machine learning model describing e.g. the network environment of the network node and how the network node may interact with other network nodes in the network. Further, the communications system 10 determines based on input data relating to the one or more of the network nodes 110, 110, 120, 122, 130, the prediction of the performance of the one or more of the network nodes 110, 110, 120, 122, 130. The determination is performed by means of the machine learning unit 300 and the machine learning model.

The input data may comprise one or more input parameters such as received signal strength, angle of arrival, measured or estimated UE speed, target block or bit error rates, just to give some examples.

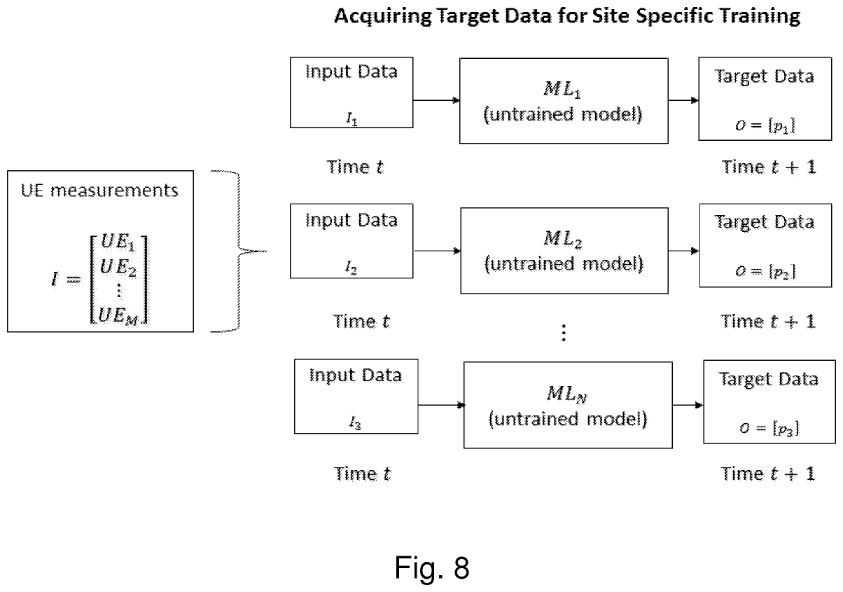

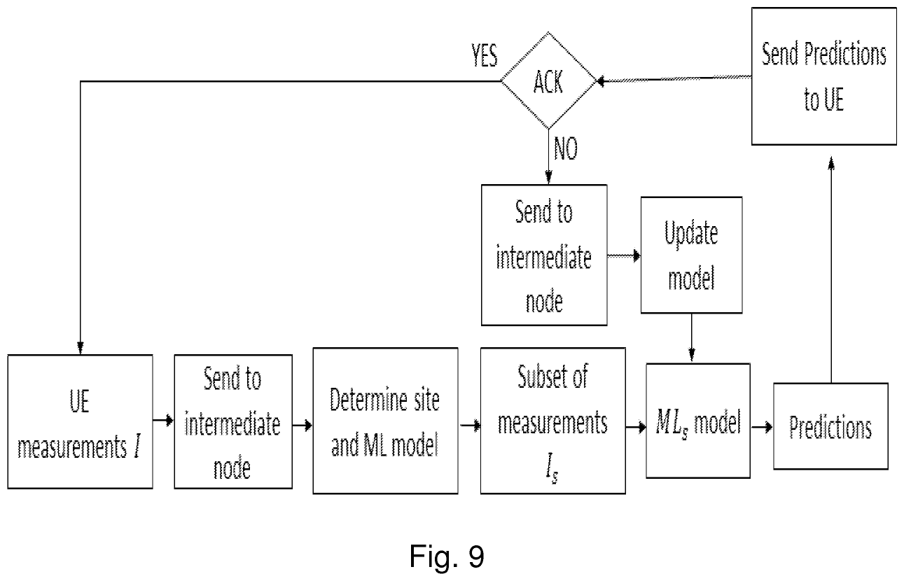

In some embodiments, such as in embodiments relating to FIGS. 8 and 9 which will be described in more detail below, the wireless communications system 10 determines the prediction of the performance of the one network node 110, 111, 120, 122, 130 by further comprising performing one or more measurements by means of the at least one network node 110, 111, 120, 122, 130, and by means of the machine learning unit 300, using information relating to the performed one or more measurements as input data to the machine learning model in order to determine the prediction of the performance of the one network node 110, 111, 120, 122, 130, wherein the prediction is based on output data from the machine learning model.

For example, the one or more measurements performed by the at least one network node 110, 111, 120, 122, 133 may be measurement of received signal strength, noise levels, angle of arrival, location and/or orientation. Thus, the information relating to the performed one or more measurements may be measurement data relating to measurements of received signal strength, noise levels, angle of arrival, location and/or orientation.

The output data from the machine learning model may be a prediction of modulation and coding scheme, transmitter beam or receiver beam to use. Further, the output data may be processed data such as decoded code words or unprocessed data such as RF chain samples, e.g. IQ samples such as IQ samples in a constellation diagram.

Action 302

The wireless communications system 10 performs one or more operations relating to the at least one network node 110, 111, 120, 122, 130 based on the determined prediction.

For example, the wireless communications system 10 may perform a change of transmit beam and/or receive beam, change of MCS selection operation based on the determined prediction of the performance of the at least one network node 110, 111, 120, 122, 130. This may for example be the case when the angle of arrival or the received signal strength changes.

Action 303

In some embodiments, such as in embodiments relating to FIGS. 8 and 9 which will be described in more detail below, to the wireless communications system 10, evaluates the machine learning model after the performing in Action 302 of the one or more operations relating to the one network node 110, 111, 120, 122, 130. This may be done to evaluate whether or not the prediction determined by means of the machine learning model and the one or more operations performed based on the prediction are good, e.g. result in an improved performance of the at least one network node 110, 111, 120, 122, 130 or of the wireless communications network as a whole.

As will be described in Action 305 below, the machine learning model may be updated based on the evaluation. For example, the wireless communications system 10 may evaluate the machine learning model by determining a block error rate after performing a change of an MCS operation. The block error rate is a ratio of the number of erroneous blocks to the total number of blocks transmitted.

Action 304

In some embodiments, the machine learning model is a representation of the at least one network node 110, 111, 120, 122, 130 to which it relates and of the one or more network nodes 110, 111, 120, 122, 130, 201, 202 communicatively connected to the one network node 110, 111, 120, 122. The machine learning model may comprise an input layer, an output layer and one or more hidden layers, wherein each layer comprises one or more artificial neurons linked to one or more other artificial neurons of the same layer or of another layer; wherein each artificial neuron has an activation function, an input weighting coefficient, a bias and an output weighting coefficient, and wherein the weighting coefficients and the bias are changeable during training of the machine learning model.

In such embodiments, the wireless communications system 10 may, by means of the machine learning unit 300, train the machine learning model based on one or more known input data and on one or more known output data relating to a result of an operation of the one network node 110, 111, 120, 122, 130 with the known input data. Each one of the one or more known output data may correspond to a respective one of the one or more known input data. This is done to train the machine learning model to perform correct or improved predictions of the performance of the network node 110, 111, 120, 122, 130. Thus, if the prediction determined based on the machine learning model and the one or more operations performed based on the prediction do not achieve a desired result, the machine learning model may be updated.

It should be understood that this training does not have to be performed in the same network node as the network node performing the prediction. If the training is done on a version of the machine learning model that is not in the same node as the machine learning model performing the prediction, then the machine learning model in the network node that does perform the prediction, which will be described in Action 305 below.

Further, in some embodiments, the wireless communications system 10, e.g. by means of the machine learning unit 300, trains the machine learning model by adjusting weighting coefficients and biases for one or more of the artificial neurons until the known output data is given as an output from the machine learning model when the corresponding known input data is given as an input to the machine learning model.

Additionally or alternatively, the wireless communications system 10 may train the machine learning model by performing a refined learning procedure. For example, the wireless communications system 10 may, by means of the at least one network node 110, 111, 120, 122, 130 or by means of another network node 110, 111, 120, 122, 130, 201, 202 comprising the machine learning unit 300, train the machine learning model by using an input parameter relating to a performance of the at least one network node 110, 111, 120, 122, 130 in order to choose one or more operations relating to the performance of the at least one network node 110, 111, 120, 122, 130. Further, the wireless communications system 10 may, by means of the at least one network node 110, 111, 120, 122, 130 or by means of another network node 110, 111, 120, 122, 130, 201, 202 comprising the machine learning unit 300, evaluate the machine learning model after performing the one or more operations relating to the performance of the at least one network node 110, 111, 120, 122, 130, and update the machine learning model based on the one or more operations. Furthermore, the wireless communications system 10 may train the machine learning model by using the received input parameter and a state relating to a network environment of the at least one network node 110, 111, 120, 122, 130 to choose one or more actions relating to the performance of the at least one network node 110, 111, 120, 122, 130.

By the expression “a state relating to a network environment” is meant a state or condition in the network environment in which the communication system operates. Some examples of quantities comprised in the state are instantaneous channel fading, number of users, and/or application requirements.

Action 305

In some embodiments, such as in embodiments relating to FIGS. 8 and 9 which will be described in more detail below, the wireless communications system 10 may update the machine learning model based on the evaluation performed in Action 303 above. This is done to update the machine learning model to perform a better or improved determination of the prediction of the performance of the network node 110, 111, 120, 122, 130. As described above in relation to Action 304, this relates to the situation where the training of the machine learning model is not performed in the network node performing the prediction based on the machine learning model. Thus, in this scenario, the training and the prediction are performed in different network nodes. The updated machine learning model, e.g. parameters of the updated machine learning model, are transmitted using the machine learning protocol.

As mentioned above, the wireless communication system 10 may perform training of the machine learning model by performing the refined learning procedure. In such embodiments, the wireless communications system 10 updates the machine learning model based on the one or more operations and based on the state relating to the environment of the at least one network node 110, 111, 120, 122, 130.

Action 306

The wireless communications system 10 transmits the determined prediction and/or information relating to the machine learning model to one or more other network nodes 110, 111, 120, 122, 130, 201, 202.

In some embodiments, the wireless communications system 10 transmits one or more out of: a node information message, a digital twin message, a training message, a machine learning model message, a security message or an update message.

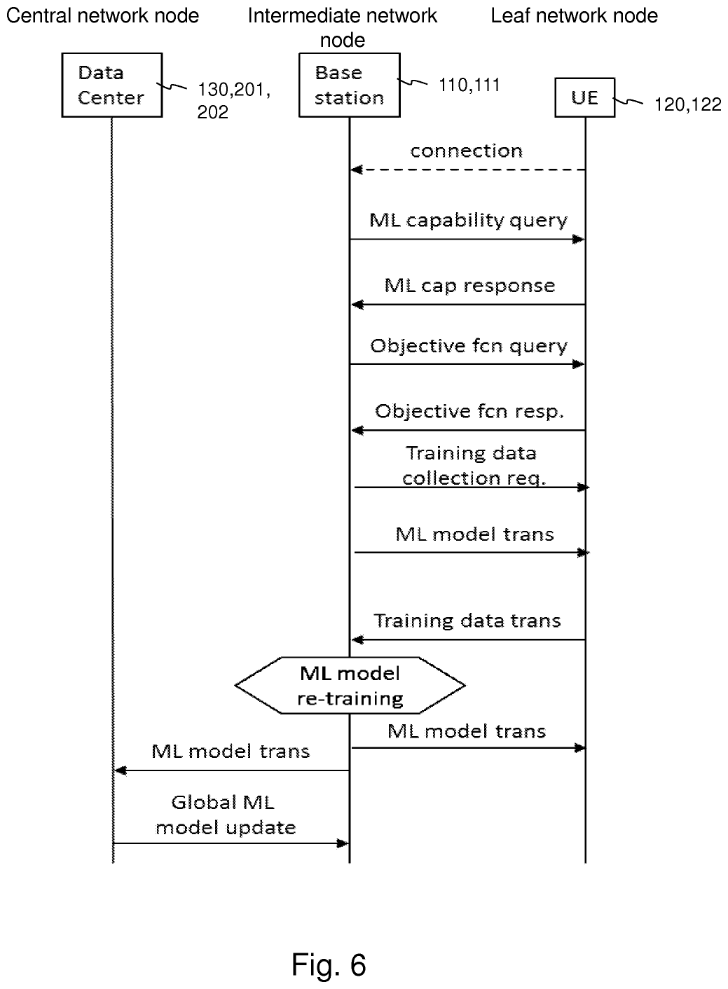

In some embodiments, e.g. in embodiments relating to FIG. 6 which will be described in more detail below, when the leaf network node 120, 122 is a communications device 120, 122 connected to the intermediate network node 110, 111, 130 being a radio network node 110, 111, and when the communications device 120, 122 connects to the radio network node 110, 111, the method performed in the wireless communication system 10 further comprises that the communications device 120, 122 transmits, to the radio network node 110, 111, information relating to one or more objectives of the communications device 120, 122. Further, the radio network node 110, 111 transmits, to the communications device 120, 122, a machine learning model suitable for the communications device's one or more objectives. Furthermore, the method performed in the wireless communications system 10 comprises that the radio network node 110, 111, requests the communications device to collect data to be used as input data for training of a machine learning model relating to the communications device 120, 122, and that the communications device 120, 122 transmits, to the radio network node 110, 111, the collected data. Yet further, by means of the radio network node 110, 111 and based on the collected data, updating the machine learning model suitable for the communications device's one or more objectives.

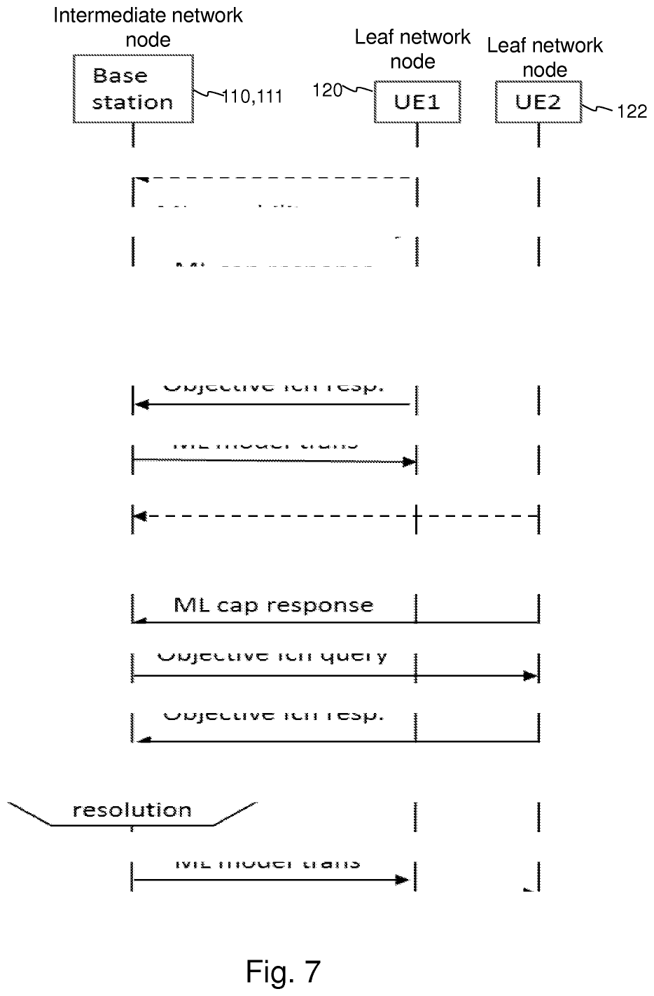

In some embodiments, e.g. in embodiments relating to FIG. 7 which will be described in more detail below, when a respective first and second leaf network node 120, 122 is a respective first and second communications device 120, 122 connected to an intermediate network node 110, 111 being a radio network node 110, 111, the method performed in the wireless communication system 10 further comprises that the radio network node 110, 111, performs a negotiation process when the first and second communications devices 120, 122 have conflicting one or more objectives and updates the respective first and second communications devices' machine learning model based on the result of the negotiation process.

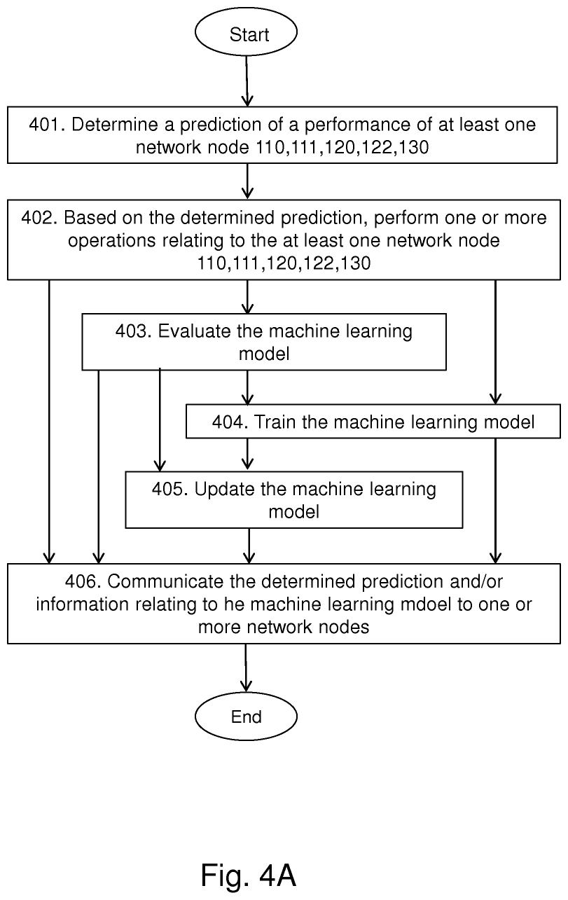

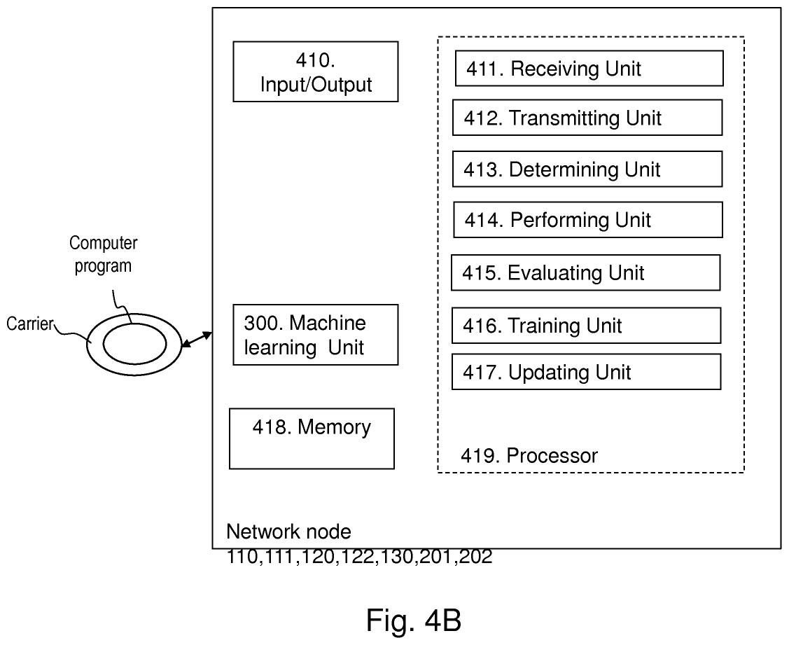

Examples of a method performed by the network node 110, 111, 120, 122, 130 for handling of machine learning to improve performance of the wireless communications network 100 operating in the wireless communications system 10 will now be described with reference to flowchart depicted in FIG. 4A. As mentioned above, the wireless communications system 10 comprises the central network node 130, 201, 202 and one or more intermediate network nodes 110, 111, 130 arranged between the central network node 130, 201, 202 and the one or more leaf network nodes 120, 122 operating in the wireless communications network 100. Further, the network node 110, 111, 120, 122, 130 comprises a machine learning unit 300. The network node 110, 111, 120, 122, 130 may be any one out of the first radio network node 110, the second radio network node 111, the first wireless device 120, the second wireless device 122, or the central node 130 e.g. depending on the network architecture. The method comprises one or more of the following actions. It should be understood that these actions may be taken in any suitable order and that some actions may be combined.

Action 401

The network node 110, 111, 120, 122, 130 determines, by means of the machine learning unit 300 and a machine learning model relating to at least one network node 110, 111, 120, 122, 130 out of the one or more intermediate network nodes 110, 111, 130 or the one or more leaf network nodes 120, 122, a prediction of a performance of the at least one network node 110, 111, 120, 122, 130 based on input data relating to the at least one network node 110, 111, 120, 122, 130.

In some embodiments, the network node 110, 111, 120, 122, 130 determines the prediction of the performance of the at least one network node 110, 111, 120, 122, 130 by obtaining information, e.g. measurement data, relating to one or more measurement performed by the one network node 110, 111, 120, 122, 130. Further, the network node 110, 111, 120, 122, 130, by means of the machine learning unit 300, uses the information relating to the performed one or more measurements as input data to the machine learning model in order to determine the prediction of the performance of the at least one network node 110, 111, 120, 122, 130. The prediction may thus be based on output data from the machine learning model.

For example, the network node 110, 111, 120, 122, 130 may use information, e.g. measurement data, relating to a received signal strength measurement and a machine learning model relating to the wireless device 120 in order to predict the MCS of the at least one network node. However, it should be understood that information relating to a performed measurement may be used to predict beam-steering or to predict changes of where certain network function are executed, just to give some other examples.

Action 402

The network node 110, 111, 120, 122, 130 performs, based on the determined prediction, one or more operations relating to the at least one network node 110, 111, 120, 122, 130.

For example, the network node 110, 111, 120, 122, 130 may perform a change of MCS operation based on the determined prediction. As another example, the network node 110, 111, 120, 122, 130 may perform a change of a beam-steering operation or change where to execute a network function based on the determined prediction.

Action 403

In some embodiments, the network node 110, 111, 120, 122, 130 evaluates the machine learning model after the performing of the one or more operations relating to the at least one network node 110, 111, 120, 122, 130.

For example, the network node 110, 111, 120, 122, 130 may evaluate block error rate after the performing of the change of MCS operation.

Action 404

In some embodiments, the network node 110, 111, 120, 122, 130 comprises the machine learning unit 300. In such embodiments, the network node 110, 111, 120, 122, 130 may, by means of the machine learning unit 300, train the machine learning model based on one or more known input data and on one or more known output data relating to a result of an operation of the one network node 110, 111, 120, 122, 130 with the known input data. Thus, in such embodiments, the network node 110, 111, 120, 122, 130 may perform actions corresponding to Actions 304 described above.

Action 405

In some embodiments, when the network node 110, 111, 120, 122, 130 has evaluated the machine learning model as described in Action 403 above, the network node 110, 111, 120, 122, 130 may update the machine learning model based on the evaluation.

For example, the network node 110, 111, 120, 122, 130 may update the parameters of the machine learning model, e.g. update one or more weights in a neural network, after evaluating that the MCS selection is too conservative and thus not fully utilizes the channel.

Action 406

The network node 110, 111, 120, 122, 130 communicates, e.g. transmits, the determined prediction and/or information relating to the machine learning model to one or more other network nodes 110, 111, 120, 122, 130, 201, 202.

In some embodiments, e.g. in embodiments relating to FIG. 6 which will be described in more detail below, when the network node 110, 111, 120, 122, 130 is a radio network node 110, 111, and when a leaf network node 120, 122 being a communications device 120, 122 connects to the radio network node 110, 111, the radio network node 110, 111 receives, from the communications device 120, 122, information relating to one or more objectives of the communications device 120, 122. The one or more objectives may for example be maximizing throughput or ensuring a specific maximum block error rate.

Further, the radio network node 110, 111 transmits, to the communications device 120, 122, a machine learning model suitable for the communications device's one or more objectives.

Furthermore, the radio network node 110, 111 transmits, to the communications device 120, 122, a request to collect data to be used as input data for training of a machine learning model relating to the communications device.

Yet further, the radio network node 110, 111, receives, from the communications device 120, 122, the collected data. Based on the received collected, data the radio network node 110, 111 updates the machine learning model suitable for the communications device's one or more objectives.

In some embodiments, the radio network node 110, 111 may transmit the updated machine learning model to the communications device 120, 122. Thus, the radio network node 110, 111 may possibly transmit the updated machine learning model to the communications device 120, 122.

In some embodiments, e.g. in embodiments relating to FIG. 7 which will be described in more detail below, the network node 110, 111, 120, 130 is a radio network node 110, 111 and a respective first and second leaf network node 120, 122 is a respective first and second communications device 120, 122 connected to radio network node 110, 111. In such embodiments, the network node 110, 111, 120, 130 performs a negotiation process when the first and second communications devices 120, 122 have conflicting one or more objectives and updating the respective first and second communications devices' machine learning model based on the result of the negotiation process.

To perform the method for handling of machine learning to improve performance of the wireless communications network 100 configured to operate in the wireless communications system 10, the network node 110 may be configured according to an arrangement depicted in FIG. 4B. As previously described, the wireless communications system 10 is configured to comprise a central network node 130, 201, 202 and one or more intermediate network nodes 110, 111, 130 arranged between the central network node 130, 201, 202 and one or more leaf network nodes 120, 122 configured to operate in the wireless communications network 100. Further, the network node 110, 111, 120, 122, 130 is configured to comprise a machine learning unit 300.

In some embodiments, the network node 110, 111, 120, 122, 130 comprises an input and/or output interface 410 configured to communicate with one or more other network nodes. The input and/or output interface 410 may comprise a wireless receiver (not shown) and a wireless transmitter (not shown).

The network node 110, 111, 120, 122, 130 is configured to receive, by means of a receiving unit 411 configured to receive, a transmission, e.g. a data packet, a signal or information, from one or more other network node 110, 111, 120, 122, 130 and/or from one or more external node 201 and/or from one or more cloud node 202. The receiving unit 411 may be implemented by or arranged in communication with a processor 419 of the network node 110, 111, 120, 122, 130. The processor 419 will be described in more detail below.

In some embodiments, e.g. in embodiments relating to FIG. 6 which will be described in more detail below, when the network node 110, 111, 120, 122, 130 is a radio network node 110, 111 and when a leaf network node 120, 122 being a communications device 120, 122 connects to the radio network node 110, 111, the network node 110, 111, 120, 122, 130 is configured to receive from the communications device 120, 122, information relating to one or more objectives of the communications device 120, 122. Further, the network node 110, 111, 120, 122, 130 is configured to receive collected data from the communications device 120, 122. The collected data may for example be received IQ samples, block error rates, angle of arrival, just to give some examples.

The network node 110, 111, 120, 122, 130 is configured to transmit, by means of a transmitting unit 412 configured to transmit, a transmission, e.g. a data packet, a signal or information, to one or more other network node 110, 111, 120, 122, 130 and/or to one or more external node 201 and/or to one or more cloud node 202. The transmitting unit 412 may be implemented by or arranged in communication with the processor 419 of the network node 110, 111, 120, 122, 130.

In some embodiments, the network node 110, 111, 120, 122, 130 is configured to communicate, e.g. transmit, the determined prediction and/or information relating to the machine learning model to one or more other network nodes 110, 111, 120, 122, 130, 201, 202.

In some embodiments, e.g. in embodiments relating to FIG. 6 which will be described in more detail below, the network node 110, 111, 120, 122, 130 is configured to transmit, to the communications device 120, 122, a machine learning model suitable for the communications device's one or more objectives, and to transmit, to the communications device 120, 122, a request to collect data to be used as input data for training of a machine learning model relating to the communications device.

Further, the network node 110, 111, 120, 122, 130 may be configured to transmit an updated machine learning model to one or more other network nodes 110, 111, 120, 122, 130 and/or to the central node 130, 201, 202. For example, if the machine learning model has been updated based on collected data received from the communications device 120, 122 the network node 110, 111, 120, 122, 130 may transmit the updated machine learning model to the communications device 120, 122.

The network node 110, 111, 120, 122, 130 may be configured to determine, by means of a determining unit 413 configured to determine, a prediction of a performance.

The determining unit 413 may be implemented by or arranged in communication with the processor 419 of the network node 110, 111, 120, 122, 130.

As previously mentioned, the network node 110, 111, 120, 122, 130 may comprise the machine learning unit 300. In such embodiments, the network node 110, 111, 120, 122, 130 is configured to determine, by means of the machine learning unit 300 and a machine learning model relating to at least one network node 110, 111, 120, 122, 130 out of the one or more intermediate network nodes 110, 111, 130 or the one or more leaf network nodes 120, 122, the prediction of the performance of the at least one network node 110, 111, 120, 122, 130 based on input data relating to the at least one network node 110, 111, 120, 122, 130. In such embodiments, the determining unit 413 may be comprised in or connected to the machine learning unit 300.

In some embodiments, the network node 110, 111, 120, 122, 130 is configured to determine the prediction of the performance of the at least one network node 110, 111, 120, 122, 130 by further being configured to obtain, from the at least one network node 110, 111, 120, 122, 130, information relating to one or more performed measurements, and by means of the machine learning unit 300, use the information relating to the one or more performed measurements as input data to the machine learning model in order to determine the prediction of the performance of the at least one network node 110, 111, 120, 122, 130, wherein the prediction is based on output data from the machine learning model.

The network node 110, 111, 120, 122, 130 is configured to perform, by means of a performing unit 414 configured to perform, an operation relating to at least one network node 110, 111, 120, 122, 130. The performing module 414 may be implemented by or arranged in communication with the processor 419 of the network node 110, 111, 120, 122, 130.

The network node 110, 111, 120, 122, 130 is configured to perform, based on the determined prediction, one or more operations relating to the at least one network node 110, 111, 120, 122, 130. For example, the network node 110, 111, 120, 122, 130 may be configured to perform transmission using a particular precoder, initialization of a handover.

In some embodiments, for example in embodiments relating to FIG. 7 which will be described in more detail below, when the network node 110, 111, 120, 130 is the radio network node 110, 111 and when a respective first and second leaf network node 120, 122 is the respective first and second communications devices 120, 122 connected to the radio network node 110, 111, the network node 110, 111, 120, 122, 130 is configured to perform a negotiation process. This may for example be the case when the first and second communications devices 120, 122 have conflicting one or more objectives.

The network node 110, 111, 120, 122, 130 may be configured to evaluate, by means of an evaluating unit 415 configured to evaluate, a machine learning model. The evaluating unit 415 may be implemented by or arranged in communication with the processor 419 of the network node 110, 111, 120, 122, 130.

In some embodiments, the network node 110, 111, 120, 122, 130 is configured to evaluate the machine learning model after the performing of the one or more operations relating to the at least one network node 110, 111, 120, 122, 130 based on the determined prediction.

The network node 110, 111, 120, 122, 130 may be configured to train, by means of a training unit 416 configured to train, a machine learning model. The training unit 416 may be implemented by or arranged in communication with the processor 419 of the network node 110, 111, 120, 122, 130.

In some embodiments and as previously described, the machine learning model is a representation of the at least one network node 110, 111, 120, 122, 130 to which it relates and of the one or more network nodes 110, 111, 120, 122, 130, 201, 202 communicatively connected to the one network node 110, 111, 120, 122. The machine learning model may comprise an input layer, an output layer and one or more hidden layers, wherein each layer comprises one or more artificial neurons linked to one or more other artificial neurons of the same layer or of another layer; wherein each artificial neuron has an activation function, an input weighting coefficient, a bias and an output weighting coefficient, and wherein the weighting coefficients and the bias are changeable during training of the machine learning model.

In such embodiments, the network node 110, 111, 120, 122, 130 may, by means of the machine learning unit 300, train the machine learning model based on one or more known input data and on one or more known output data relating to a result of an operation of the one network node 110, 111, 120, 122, 130 with the known input data. Each one of the one or more known output data may correspond to a respective one of the one or more known input data.

Further, in some embodiments, the network node 110, 111, 120, 122, 130, e.g. by means of the machine learning unit 300, trains the machine learning model by adjusting weighting coefficients and biases for one or more of the artificial neurons until the known output data is given as an output from the machine learning model when the corresponding known input data is given as an input to the machine learning model.

Additionally or alternatively, the network node 110, 111, 120, 122, 130 may train the machine learning model by performing a refined learning procedure. For example, the network node 110, 111, 120, 122, 130 may train the machine learning model by using an input parameter relating to a performance of the at least one network node 110, 111, 120, 122, 130 in order to choose one or more operations relating to the performance of the at least one network node 110, 111, 120, 122, 130. Further, the network node 110, 111, 120, 122, 130 evaluate the machine learning model after performing the one or more operations relating to the performance of the at least one network node 110, 111, 120, 122, 130, and update the machine learning model based on the one or more operations. Furthermore, the network node 110, 111, 120, 122, 130 may train the machine learning model by using the received input parameter and a state relating to an environment of the at least one network node 110, 111, 120, 122, 130 to choose one or more actions relating to the performance of the at least one network node 110, 111, 120, 122, 130.

The network node 110, 111, 120, 122, 130 may be configured to update, by means of an updating unit 417 configured to update, a machine learning model. The updating unit 417 may be implemented by or arranged in communication with the processor 419 of the network node 110, 111, 120, 122, 130.

In some embodiments, when the network node 110, 111, 120, 122, 130 has evaluated the machine learning model, the network node 110, 111, 120, 122, 130 may possibly update the machine learning model based on the evaluation. This may for example be the case when the network node 110, 111, 120, 122, 130 during the evaluation has determined that an MCS selection is too conservative leading to an underutilization of the channel and then then machine learning model has to be updated to take this into consideration.

When the network node 110, 111, 120, 122, 130 has performed the negotiation process as described above, the network node 110, 111, 120, 122, 130 may update the respective first and second communications devices' machine learning model based on the result of the negotiation process.

In some embodiments, when the network node has received collected data as described above, the network node 110, 111, 120, 122, 130 is configured to, based on the received collected data, update the machine learning model suitable for the communications device's one or more objectives.

The network node 110, 111, 120, 122, 130 may also comprise means for storing data. In some embodiments, the network node 110, 111, 120, 122, 130 comprises a memory 418 configured to store the data. The data may be processed or non-processed data and/or information relating thereto. The memory 418 may comprise one or more memory units. Further, the memory 419 may be a computer data storage or a semiconductor memory such as a computer memory, a read-only memory, a volatile memory or a non-volatile memory. The memory is arranged to be used to store obtained information, data, configurations, and applications etc. to perform the methods herein when being executed in the network node 110, 111, 120, 122, 130.

Embodiments herein for handling of machine learning to improve performance of the wireless communications network 100 configured to operate in the wireless communications system 10 may be implemented through one or more processors, such as the processor 419 in the arrangement depicted in FIG. 4B, together with computer program code for performing the functions and/or method actions of embodiments herein. The program code mentioned above may also be provided as a computer program product, for instance in the form of a data carrier carrying computer program code for performing the embodiments herein when being loaded into the network node 110, 111, 120, 122, 130. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the network node 110, 111, 120, 122, 130.

Those skilled in the art will also appreciate that the input/output interface 410, the receiving unit 411, the transmitting unit 412, the determining unit 413, the performing unit 414, the evaluating unit 415, the training unit 416, or the updating unit 417, one or more possible other units above may refer to a combination of analogue and digital circuits, and/or one or more processors configured with software and/or firmware, e.g. stored in the memory 418, that when executed by the one or more processors such as the processors in the network node 110, 111, 120, 122, 130 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

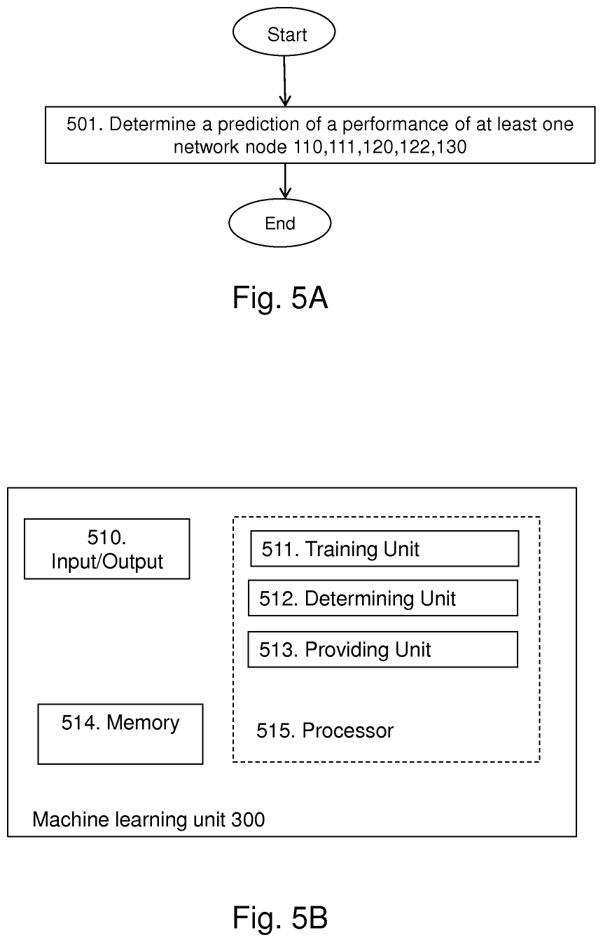

Examples of a method performed by the machine learning unit 300 for handling of machine learning to improve performance of the wireless communications network 100 operating in the wireless communications system 10 will now be described with reference to flowchart depicted in FIG. 5A. As mentioned above, the wireless communications system 10 comprises the central network node 130, 201, 202 and one or more intermediate network nodes 110, 111, 130 arranged between the central network node 130, 201, 202 and one or more leaf network nodes 120, 122 operating in the wireless communications network 100. Further, at least one out of: the central network node 130, 201, 202, the one or more intermediate network nodes 110, 111, 130 or the one or more leaf network nodes 120 comprises the machine learning unit 300.

The method comprises one or more of the following actions. It should be understood that these actions may be taken in any suitable order and that some actions may be combined.

Action 501

The machine learning unit 300 determines, by means of a machine learning model relating to at least one network node 110, 111, 120, 122, 130 out of the one or more intermediate network nodes 110, 111, 130 or the one or more leaf network nodes 120, 122 and based on input data relating to the at least one network node 110, 111, 120, 122, 130, a prediction of a performance of the at least one network node 110, 111, 120, 122, 130.

Further, in some embodiments and as previously described, the machine learning unit 300 trains the machine learning model based on one or more known input data and on one or more known output data relating to a result of an operation of the one network node 110, 111, 120, 122, 130 with the known input data. Each one of the one or more known output data may correspond to a respective one of the one or more known input data.

Further, in some embodiments, the machine learning unit 300 trains the machine learning model by adjusting weighting coefficients and biases for one or more of the artificial neurons until the known output data is given as an output from the machine learning model when the corresponding known input data is given as an input to the machine learning model.

Additionally or alternatively, the machine learning unit 300 may train the machine learning model by performing a refined learning procedure. For example, the machine learning unit 300 may train the machine learning model by using an input parameter relating to a performance of the at least one network node 110, 111, 120, 122, 130 in order to choose one or more operations relating to the performance of the at least one network node 110, 111, 120, 122, 130. Further, the machine learning unit 300 may evaluate the machine learning model after performing the one or more operations relating to the performance of the at least one network node 110, 111, 120, 122, 130, and update the machine learning model based on the one or more operations. Furthermore, the machine learning unit 300 may train the machine learning model by using the received input parameter and a state relating to an environment of the at least one network node 110, 111, 120, 122, 130 to choose one or more actions relating to the performance of the at least one network node 110, 111, 120, 122, 130.

To perform the method for handling of machine learning to improve performance of the wireless communications network 100 configured to operate in the wireless communications system 10, the machine learning unit 300 may be configured according to an arrangement depicted in FIG. 5B. As mentioned above, the wireless communications system 10 is configured to comprise the central network node 130, 201, 202 and one or more intermediate network nodes 110, 111, 130 arranged between the central network node 130, 201, 202 and one or more leaf network nodes 120, 122 configured to operate in the wireless communications network 100. Further, at least one out of: the central network node 130, 201, 202, the one or more intermediate network nodes 110, 111, 130 or the one or more leaf network nodes 120 is configured to comprise the machine learning unit 300.

In some embodiments, the machine learning unit 300 comprises an input and/or output interface 510 configured to communicate with one or more central network nodes 130, one or more wireless devices, e.g. the wireless devices 120, 122 and/or one or more network nodes, e.g. the first and second radio network nodes 110, 111. The input and/or output interface 510 may comprise a wireless receiver (not shown) and a wireless transmitter (not shown).

The machine learning unit 300 may be configured to train, by means of a training unit 511 configured to train, one or more machine learning models. The training unit 511 may be implemented by or arranged in communication with a processor 515 of the machine learning unit 300. The processor 515 will be described in more detail below.

Further, in some embodiments and as previously described, the machine learning unit 300 is configured to train the machine learning model based on one or more known input data and on one or more known output data relating to a result of an operation of the one network node 110, 111, 120, 122, 130 with the known input data. Each one of the one or more known output data may correspond to a respective one of the one or more known input data.

Further, in some embodiments, the machine learning unit 300 is configured to train the machine learning model by adjusting weighting coefficients and biases for one or more of the artificial neurons until the known output data is given as an output from the machine learning model when the corresponding known input data is given as an input to the machine learning model.

Additionally or alternatively, the machine learning unit 300 may be configured to train the machine learning model by performing a refined learning procedure. For example, the machine learning unit 300 may be configured t train the machine learning model by using an input parameter relating to a performance of the at least one network node 110, 111, 120, 122, 130 in order to choose one or more operations relating to the performance of the at least one network node 110, 111, 120, 122, 130. Further, the machine learning unit 300 may be configured to evaluate the machine learning model after performing the one or more operations relating to the performance of the at least one network node 110, 111, 120, 122, 130, and to update the machine learning model based on the one or more operations. Furthermore, the machine learning unit 300 may be configured to train the machine learning model by using the received input parameter and a state relating to an environment of the at least one network node 110, 111, 120, 122, 130 to choose one or more actions relating to the performance of the at least one network node 110, 111, 120, 122, 130.

The machine learning unit 300 is configured to determine, by means of a determining unit 512 configured to determine, a prediction of a performance of at least one network node 110, 111, 120, 122, 130. The determining unit 512 may be implemented by or arranged in communication with the processor 515 of the machine learning unit 300.

The machine learning unit 300 is configured to determine, by means of a machine learning model relating to at least one network node 110, 111, 120, 122, 130 out of the one or more intermediate network nodes 110, 111, 130 or the one or more leaf network nodes 120, 122 and based on input data relating to the at least one network node 110, 111, 120, 122, 130, a prediction of a performance of the at least one network node 110, 111, 120, 122, 130.

The machine learning unit 300 is configured to provide, by means of a providing unit 513 configured to provide, information to one or more network nodes network node 110, 111, 120, 122, 130, 201, 202. For example, the information may relate to determined predictions for a network node. The providing unit 513 may be implemented by or arranged in communication with the processor 515 of the machine learning unit 300.

The machine learning unit 300 may also comprise means for storing data. In some embodiments, the machine learning unit 300 comprises a memory 604 configured to store the data. The data may be processed or non-processed data and/or information relating thereto. The memory 514 may comprise one or more memory units. Further, the memory 514 may be a computer data storage or a semiconductor memory such as a computer memory, a read-only memory, a volatile memory or a non-volatile memory. The memory is arranged to be used to store obtained information, data, configurations, and applications etc. to perform the methods herein when being executed in the machine learning unit 300.

Embodiments herein for handling of machine learning to improve performance of the wireless communications network 100 operating in the wireless communications system 10 may be implemented through one or more processors, such as the processor 515 in the arrangement depicted in FIG. 5B, together with computer program code for performing the functions and/or method actions of embodiments herein. The program code mentioned above may also be provided as a computer program product, for instance in the form of a data carrier carrying computer program code for performing the embodiments herein when being loaded into the machine learning unit 300. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the machine learning unit 300.

Those skilled in the art will also appreciate that the input/output interface 510, the training unit 511, the determining unit 512, the providing unit 513, one or more possible other units above may refer to a combination of analogue and digital circuits, and/or one or more processors configured with software and/or firmware, e.g. stored in the memory 514, that when executed by the one or more processors such as the processors in the machine learning unit 300 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

### Some Exemplifying Embodiments

Some exemplifying communications protocols for exchange of machine intelligence information between network nodes will now be described with reference to FIGS. 6 and 7. FIGS. 6 and 7 are combined flowcharts and signalling schemes schematically illustrating embodiments of methods performed in a wireless communications system such as the wireless communications system 10.

In a wireless communication system, such as the wireless communications system 10, wherein the communication is a goal, the communication protocols should not be too large in order not to cause unnecessary overhead and delay in the communications system. The requirement on the size of the communications protocols prevents all training data and models from being exchanged as a layer on top, since that will use too much of the capacity that is needed for the user-serving communications. On the other hand, when fully functional, it will be up to the smart network architecture and protocol to determine the communication that is the appropriate communication.

A drawback with the prior art systems, is the large amount of data required in the training sets and the large number of parameters required in the machine learning models, e.g., in deep neural networks.

A protocol for exchange of information, e.g. data, related to machine intelligence in the wireless communications network 10 is provided according to embodiments herein. The protocol handles different types of messages. For example, the protocol may handle the following types of messages:
Node information message comprising e.g. node ML model capabilities, node capabilities in terms of processing/learning and storage, types of training data available and needed, etc.
Messages comprising digital twin objectives comprising e.g. objective(s) of device/user, feature selection and importance based on training objective/output, Quality level indicators (e.g., minimum useful/acceptable, normal, high), etc.
Training messages comprising e.g. feature descriptions, single training example, multiple training examples, compressed training messages, etc.
ML model messages comprising e.g. model descriptions (model types, structure description), model parameters, meta-data on what training data models are based on, message whether to use existing ML model in device or receive ML model from BS or repository, etc.
Security messages comprising e.g. trust and certification messages, intrusion detection messages, spoofing avoidance messages, etc.
Update messages comprising e.g. cluster assignment messages, architecture update messages, protocol update messages, etc.

Additional message types and messages may be expected when network AI capabilities are developed.

The exact contents of the messages may be subject to further optimization and standardization.

Two examples of protocol usage are given in FIGS. 6 and 7. The order of the exchanges may be different, and some messages may be bundled. For example, it may be possible to combine the ML capability query and Objective function query into one message.

FIG. 6 shows an example where the wireless device 120, 122, referred to as UE in FIG. 6, has limited ML capabilities and attaches to the radio network node 110, 111 and ML message exchange takes place. Further, in the text below, the terms in brackets are terms shown in FIG. 6.

First, the device, e.g. the wireless device 120, 122, attaches to the radio network node 110, 111, referred to as BS in FIG. 6, [connection]. This may either be through the existing protocols or included in the presented protocol by addition of signalling messages and/or signalling capabilities. If the attachment procedure is a part of the Intelligent RAN protocol, the ML capabilities may be signalled in the attachment procedures, similar to 3GPP UE category signalling [3GPP TS 36.310 and 3GPP TS 36.331]. If the attachment procedure is not included, then a separate message exchange may take place to determine the wireless device's/UE's ML capabilities. The BS queries the UE/device about its ML capabilities [ML capability query] and the UE/device responds [ML capability response].

When the ML capabilities have been determined, the BS, e.g. the radio network node 110, 111, queries the UE, e.g. the wireless device 120, 122, for its objective function(s) [Objective function query]. In the mature intelligent RAN, this objective function may be quite complex and describe a multi-faceted desire and/or purpose of the user/device. Initially, the objective function may be more limited, e.g., relate to data rates, acceptable latencies, error rates. It may also comprise ML-related objectives, e.g., error function, training stopping criteria. The UE responds with its objective [Objective function response]. This may include transmitting the UE's digital twin if this is not already available on the network side, e.g. at the BS.

In the present example, the UE, e.g. the wireless device 120, 122, is assumed to have limited ML capabilities. The BS, e.g. the radio network node 110, 111, will have to perform the learning and the device may only use the ML model for predictions. Thus, the BS requests the device to start collecting training data [Training data collection request] for later processing in the BS. The device's ability to collect and store data may either be signalled in the ML capability response, or in separate messages (not shown in the figure).

The BS, e.g. the radio network node 110, 111, then transmits a ML model suitable for the device's objective function and capabilities [ML model transmission].

After some period of time, the wireless device has collected a suitable amount of training data, and this is transmitted to the BS [Training data transmission].

The BS then updates the ML model based on the received training data [ML model re-training]. After the refinement of the ML model(s), the BS transmits the updated model to the device [ML model transmission] and to nodes concerned with clustered/global models related to the current device type and objective function(s) [ML model transmission]. When the global model(s) has been refined, then the updated global model is distributed [Global ML model update]. If relevant, the global model may be sent to the wireless device 120, 122 (not shown in FIG. 6).

Alternatively, update messages are only transmitted if the (accumulated) update to a ML model exceeds some threshold. This minimizes the signalling, but the node keeping the most current version must ensure that updates are not lost. E.g., even if the changes do not exceed the threshold, the updated model may be transmitted to central nodes when the wireless device 120, 122 disconnects from the BS, e.g. the radio network node 110, 111.

FIG. 7 shows an example of multiple UEs, e.g. the first and second wireless devices 120, 122, with potentially conflicting objective functions. First, a single UE UE1, e.g. the first wireless device 120, is connecting to the BS, e.g. the radio network node 110, 111, as in the previous example. Further, in the text below, the terms in brackets are terms shown in FIG. 7. We here assume more capable UEs and that the UEs may handle the ML model and possible training of the model. If the ML model is stored in the UE, the [ML model transmission] message indicates that the on-board model should be used, and which model to use if multiple models are available. If the most current model is not on-board, then the model parameters are transmitted in this message.

After some time, a second UE UE2, e.g. the second wireless device 122, attaches to the BS, e.g. the radio network node 110, 111, in the same way as the first wireless device 120, e.g. that the actions of [connection], [ML capability query], [ML capability response], [Objective function query] and [Objective function response] are performed. There may now be a resource conflict depending on the two UEs' objective functions. The BS resolves this conflict through a negotiation process [Objective function resolution]. The BS, e.g. the radio network node 110, 111, may consult one or more network nodes in higher layers where more complex global models are available (not shown in the figure). When the conflict has been resolved, the BS transmits the appropriate models including, resource utilization limitations, if any, to the UEs [ML model transmission].

The objective function negotiation takes place when a UE/device, e.g. the wireless device 120, 122, attaches or leaves the serving BS, e.g. the wireless device 120, 122.

This negotiation process may be similar to the Radio Resource Management (RRM) allocation taking place in the scheduler, but here it is not determined by a deterministic algorithm but through a learning negotiating process, e.g. a continuously updated negotiation process.

Similarly, the protocol may be used to exchange ML models between different BSs and cluster heads, assigning and reassigning BS to different clusters, select cluster heads and determine cluster-common learning objectives.

The proposed architecture and protocol provides an initial version of the intelligent RAN architecture and protocols. When the wireless communications system becomes intelligent, it is expected to improve itself autonomously and thus update architecture and protocols autonomously to maximize the goal fulfilment and resource utilization. For example, when and where different functions are performed will be assessed and relocation of functions and/or addition of functions and/or removal of functions between physical network nodes may take place using the architecture update messages. Improvement to the protocol itself takes place using the protocol update messages.

### Some Examples of Usage

A general example of how the training and prediction may work in the proposed architecture for machine learning in the communications system 10 will now be given. However, the description will not include the specific protocols involved in the example below.

Training

During a training mode, the system, e.g. the wireless communications system 10, is run normally to acquire the target data. A particular example of inputs and outputs will not be given. Many different things may be learnt from the communication system. Once the different machine learning models are trained, the predictions may be exploited to reduce complexity, overhead, and delay by predicting useful information about the network environment, e.g. the propagation environment, in the communications network. The intention may be to gather as much information and/or data as possible. The information and/or data may then be split into subsection depending on what features are informative for different predictions. Then several site-specific ML models may be trained for different purposes, predicting different outputs. For example, one of the site-specific ML models may take as input several CSI-RS values in order to determine a beam prediction. Another ML model may be trained to monitor the link quality to perform prediction of link adaptation. A goal may be to train several ML models per site. However, all machine learning models may not be used at each time instant, since that may be too complex. The wireless device 120, 122 may choose or be told what measurements to perform. The machine learning models may be stored in an external node 201 or in a cloud node 202 in the cloud 203 or at one of the intermediate nodes 110, 110, 130. Several different ML models may be provided for several different sites. Information gathered from the wireless device 120, 122, such as cell id and location information may be used to determine which site the wireless device 120, 122 currently occupies. Therefore, it is known which inputs to send to the correct ML learning model. Feature importance methods may be used to get information on what the relevant features are for different predictions. The UE measurements I, comprising measurements from e.g. UE₁, UE₂, . . . UE_{M}, may be split into relevant subsections to prepare the inputs, for a point of time t, e.g. input data I₁, I₂, I₃, for their respective ML model, e.g. ML₁, ML₂, . . . ML_{N}. The system is to be run normally to acquire the target data (output) for a point of time t+1. The target data is the data desired to predict, e.g. p₁, p₂, p₃, at the point of time t+1. This example is illustrated in FIG. 8. FIG. 8 schematically illustrates training of several machine learning models ML₁, ML₂, . . . ML_{N} at one site, e.g. at one network node. The system 10 may be trained at the external node 201 or at the cloud node 202 on the cloud or at one of the intermediate nodes 110, 111, 130. This means that the wireless device 120, 122 needs to send its measurements and the target data to the network node that will perform the training. This will depend on the computational capability of the network node, the storage capacity and the current load. One of the benefits of having distributed network nodes, is the possibility of exchanging this type of information so a possible node for training and/or storing the prediction model may be identified. In the training mode, the predictions do not need to be sent back to the wireless device 120, 122. However, in the prediction (online) mode it is needed to send the predictions from the external node 201, the cloud node 202 or one of the intermediate nodes 110, 111, 130 to the wireless device 120, 122. However, it should be understood that this is only one possible way. It is also possible to imagine a scenario where the model is sent to the wireless device 120, 122 being capable of performing the prediction. This would mitigate the need to send measurements to the external node 201, the cloud node 202 or to one of the intermediate nodes 110, 111, 130 which would decrease overhead in the communications network 100.

The machine learning model may trained by minimizing a loss function, for example the Mean Squared Error (MSE). Note that the dimension of the inputs and outputs may need to remain fixed for both the training and prediction (online). Different ML models may of course have different inputs and outputs but once the models have been trained, the dimension of the inputs and output for both the training and prediction need to be fixed. Once the systems are trained, it is possible to predict the outputs given the inputs.

It is important to choose a good machine learning method for the particular purpose of the prediction model. For example, if being interested in a problem where sequential information is essential, e.g. when monitoring radio quality of a link, the notion of time is needed to be taken into account. Therefore, it may be good to use a recurrent neural network or long short-term memory networks. Further, learning architectures that have a form of memory and takes time into account may need to be used since such structures are able to take the sequential information into account. If on the other hand the notion of time in unimportant, a feedforward neural network or tree-structured learning methods etc. may be used. Thus, appropriate ML architectures need to be chosen depending on the type of problem.

Prediction

In prediction (e.g. online), see FIG. 9, the dimensions of the input and outputs remain the same as in the training mode. Here, there is no need to run the system normally. The goal here is to save overhead and complexity by using the trained ML models that give the desired predictions.

An exemplary refined learning method will be described which method updates the trained prediction models used in the communications system 10 to maintain reliable estimates during prediction (online) mode. By using the information of the ACK/NACK it is possible to measure the quality of the predictions. This information may be used to update the trained ML models for the different sites accordingly. It should be noted that in the example, the model is only updated when the prediction was not correct. However, the model may be updated even when the prediction was not correct. Further, other more advanced updating methods may be used.

An example of the steps involved in the prediction (online) shown in FIG. 9 will now be described. See box named “UE measurements I” in FIG. 9.

Firstly, the UE, e.g. the wireless device 120, 122, performs and gathers measurements I. This may be many different things, for example CSI-RS measurements from different beams, sensor information and/or location information, BLER, all manner of different features. Sometimes it is desired to acquire as much data as possible.

Secondly, the gathered information is sent to the intermediate node 110, 111, 130 comprising the trained, site-specific prediction models, e.g. the machine learning model relating to the wireless device 120, 122. Information is used from the measurements to determine which site the wireless device 120, 122 currently occupies. The measurements are split into the relevant subsets of measurements Is and fed to the trained prediction models ML_{S}. This will give us a number of predictions.

Thirdly, the predictions are sent to the UE, e.g. the wireless device 120, 122, and the wireless device applies them to the link.

Fourthly, ACK/NACK information is used as an indication of the uncertainty of estimates. A ‘yes’ would return to the next set of UE measurements I. A ‘no’ would trigger an update of the relevant machine learning model at a network node, e.g. a machine learning model comprised in an intermediate node or on the cloud. In case the machine learning model is on the cloud, e.g. on the cloud node 202, it may be needed to send extra information to the cloud so that it may perform the relevant updates. After this, the predictions based on the relevant subset of measurements Is fed to the updated relevant models ML_{S} are determined and the cycle continues.

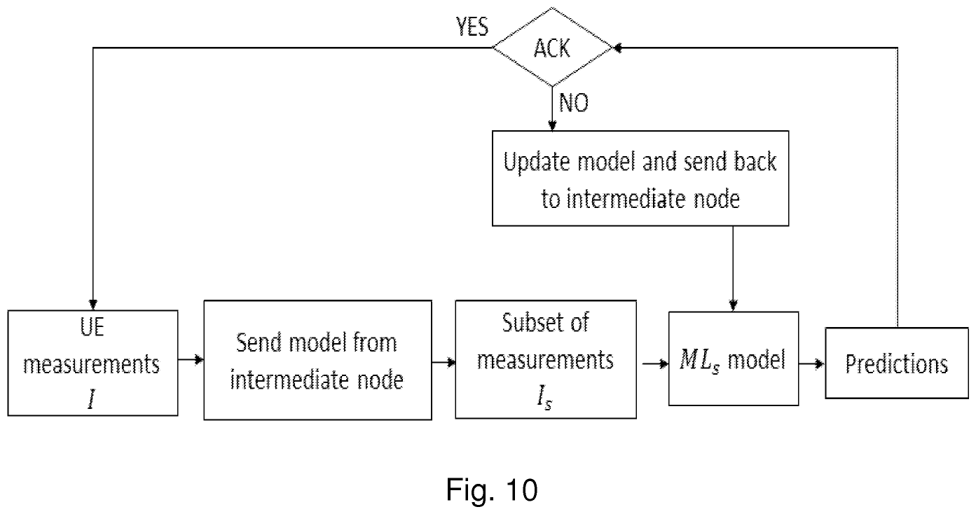

In the description above, it may be assumed that the model is trained at the external node 201, the cloud node 202 or at one of the intermediate nodes 110, 111, 130. The wireless device 120, 122 transmits the required information to the external node 201, the cloud node 202 or to one of the intermediate nodes 110, 111, 130. However, in another scenario, the relevant model is sent to the wireless device 120, 122. This would avoid some of the measurement signalling. The wireless device 120, 122 may then acquire the estimates and update the model before sending it back to the external node 201, the cloud node 202 or to one of the intermediate nodes 110, 111, 130. See FIG. 10 for an illustration of this example. In both cases, extra signalling may be required. However, access to this data may be needed in order to learn the environment where the access point is operating. Sites typically have different network environments, e.g. different propagation environments, and having a separate machine learning model, e.g. a prediction model, per site will be advantageous as the machine learning model will be able to learn the environment. Training and prediction may be run simultaneously in the system 10.

A fall back procedure may be to run the system normally without performing any predictions. For example, that may be needed if several NACKs are obtained in a row.

The prediction model, i.e. the machine learning model, may be a supervised learning method in the training and an unsupervised (online) learning method in the deployed, prediction. Reliable ML models are maintained during prediction by constantly updating them based on the accuracy of the prediction. One may also use reinforcement techniques to avoid pre-training of the wireless communications system. In the future when machine learning will become more common place in the communication system, the framework for model handover and model communication will be very important. Therefore, embodiments herein provide an architecture for that framework.

### Further Extensions and Variations

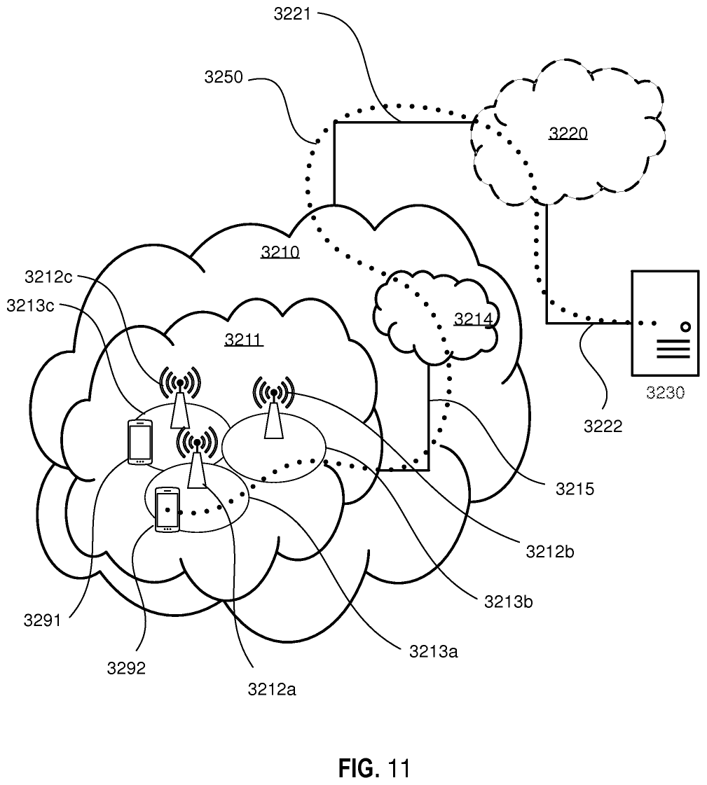

With reference to FIG. 11, in accordance with an embodiment, a communication system includes a telecommunication network 3210 such as the wireless communications network 100, e.g. a WLAN, such as a 3GPP-type cellular network, which comprises an access network 3211, such as a radio access network, e.g. the RAN 101, and a core network 3214, e.g. the CN 102. The access network 3211 comprises a plurality of base stations 3212a, 3212b, 3212c, such as the network node 110, 111, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless device 120, 122 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220, e.g. the external network 200. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

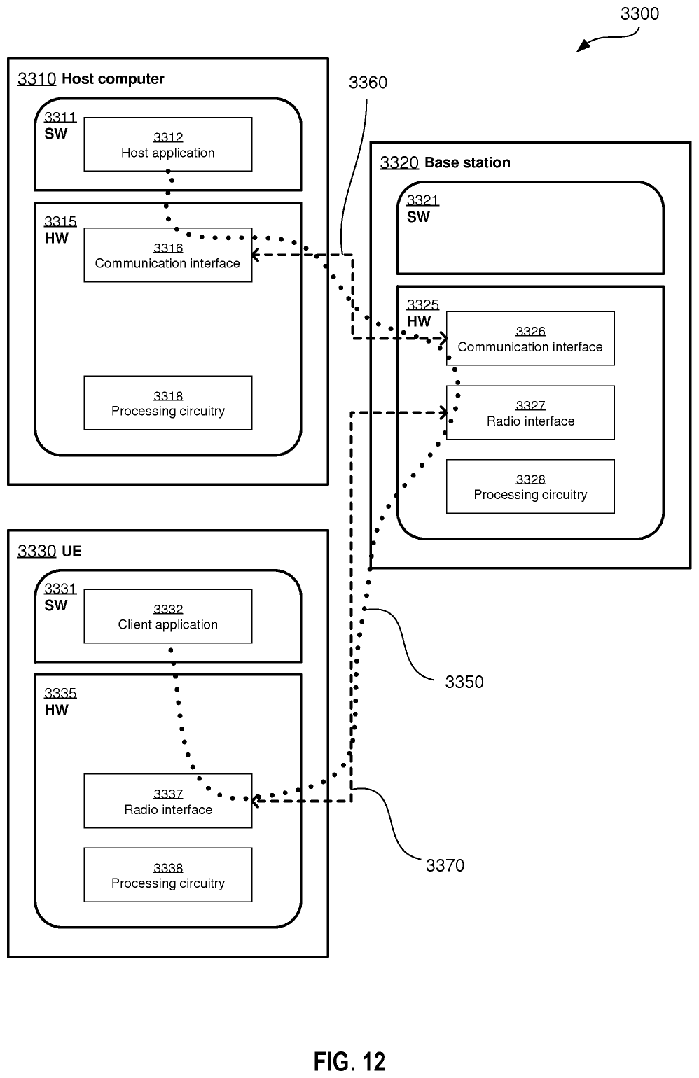

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may reduce the signalling overhead and thus improve the data rate. Thereby, providing benefits such as reduced user waiting time, relaxed restriction on file size, and/or better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

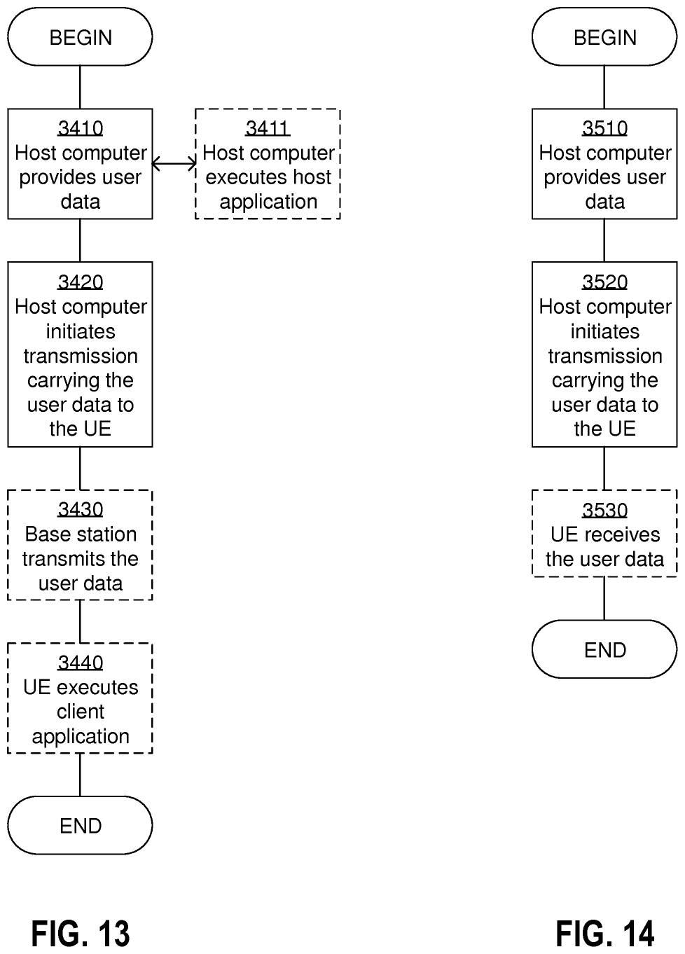

FIG. 13 is a flowchart illustrating a method implemented in a communication system, in accordance with one embodiment. The communication system includes a host computer, a base station such as an AP STA, and a UE such as a Non-AP STA which may be those described with reference to FIGS. 11 and 12. For simplicity of the present disclosure, only drawing references to FIG. 13 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 14 is a flowchart illustrating a method implemented in a communication system, in accordance with one embodiment. The communication system includes a host computer, a base station such as an AP STA, and a UE such as a Non-AP STA which may be those described with reference to FIGS. 11 and 12. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

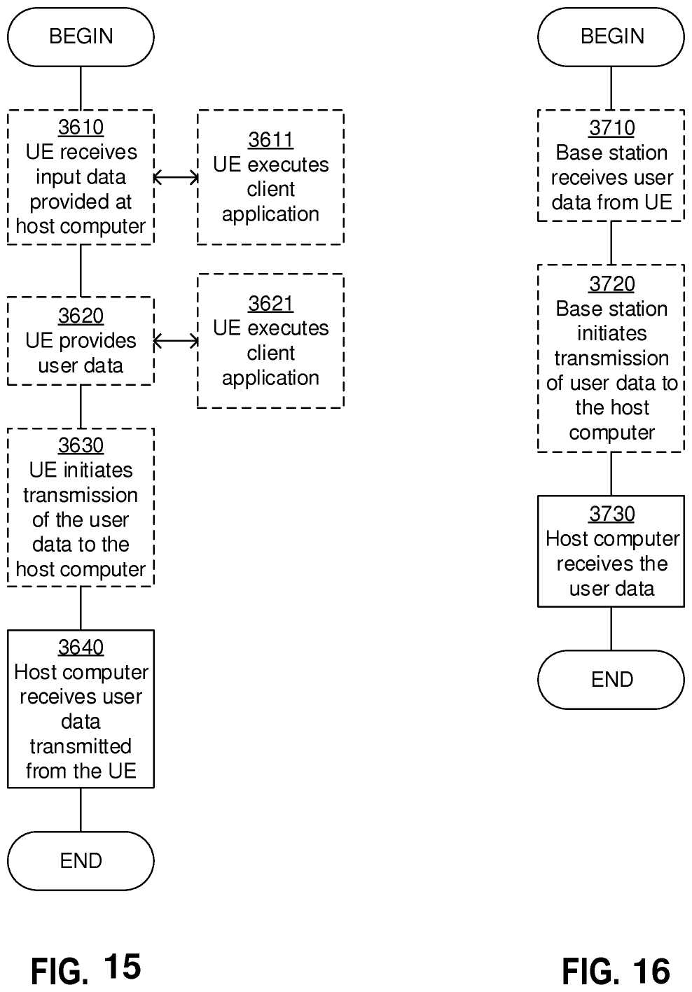

FIG. 15 is a flowchart illustrating a method implemented in a communication system, in accordance with one embodiment. The communication system includes a host computer, a base station such as a AP STA, and a UE such as a Non-AP STA which may be those described with reference to FIGS. 11 and 12. For simplicity of the present disclosure, only drawing references to FIG. 15 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 16 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Abbreviation Explanation

| | |
|---|---|
| ACK | Acknowledgement |
| AI | Artificial Intelligence |
| BLER | Block Error Rate |
| BS | Base Station |
| CSI-RS | Channel State Information Reference Symbols |
| IA | Intelligent Agent |
| IoT | Internet of Things |
| MBB | Mobile Broadband |
| MI | Machine Intelligence |
| ML | Machine Learning |
| NACK | Negative Acknowledgement |
| RRM | Radio Resource Management |
| RX | Receiver |
| TX | Transmitter |
| UE | User Equipment |

1. A method performed in a wireless communications system for handling of machine learning to improve performance of a wireless communications network operating in the wireless communications system, the wireless communications system comprising a central network node and one or more intermediate network nodes arranged between the central network node and one or more leaf network nodes operating in the wireless communications network, at least one out of: the central network node, the one or more intermediate network nodes or the one or more leaf network nodes comprising a machine learning unit, the method comprising:
by means of the machine learning unit and a machine learning model relating to at least one network node out of the one or more intermediate network nodes or the one or more leaf network nodes, determining a prediction of a performance of the at least one network node based on input data relating to the at least one network node;
based on the determined prediction, performing one or more operations relating to the at least one network node; and
transmitting at least one of the determined prediction and information relating to the machine learning model to one or more other network nodes.

2. The method of claim 1, wherein a leaf network node is a communications device connected to an intermediate network node being a radio network node, wherein the method further comprises:
when the communications device connects to the radio network node, the communications device transmits information relating to one or more objectives of the communications device;
transmitting, from the radio network node to the communications device, a machine learning model suitable for the communications device's one or more objectives;
by means of the radio network node, requesting the communications device to collect data to be used as input data for training of a machine learning model relating to the communications device;
transmitting from the communications device to the radio network node the collected data; and
by means of the radio network node and based on the collected data, updating the machine learning model suitable for the communications device's one or more objectives.

3. The method of claim 1, wherein a respective first and second leaf network node is a respective first and second communications device connected to an intermediate network node being a radio network node, wherein the method further comprises:
by means of the radio network node, performing a negotiation process when the first and second communications devices have conflicting one or more objectives and updating the respective first and second communications devices' machine learning model based on the result of the negotiation process.

4. The method of claim 1, wherein the determining of the prediction of the performance of the one network node comprises:
by means of the at least one network node, performing one or more measurements; and
by means of the machine learning unit, using information relating to the performed one or more measurements as input data to the machine learning model in order to determine the prediction of the performance of the one network node, wherein the prediction is based on output data from the machine learning model.

5. The method of claim 1, further comprising:
evaluating the machine learning model after the performing of the one or more operations relating to the one network node based on the determined prediction; and
updating the machine learning model based on the evaluation.

6. The method of claim 1, wherein the machine learning model is a representation of the at least one network node to which it relates and of the one or more network nodes communicatively connected to the one network node, wherein the machine learning model comprises an input layer, an output layer and one or more hidden layers, wherein each layer comprises one or more artificial neurons linked to one or more other artificial neurons of one of the same layer and of another layer; wherein each artificial neuron has an activation function, an input weighting coefficient, a bias and an output weighting coefficient, and wherein the weighting coefficients and the bias are changeable during training of the machine learning model, wherein the method further comprises:
by means of the machine learning unit, training the machine learning model based on one or more known input data and on one or more known output data relating to a result of an operation of the one network node with the known input data, wherein each one of the one or more known output data corresponds to a respective one of the one or more known input data.

7. The method of claim 6, wherein the training of the machine learning model comprises:
adjusting weighting coefficients and biases for one or more of the artificial neurons until the known output data is given as an output from the machine learning model when the corresponding known input data is given as an input to the machine learning model.

8. The method of claim 1, further comprising:
by means one of the at least one network node and of another network node comprising the machine learning unit, training the machine learning model by using an input parameter relating to a performance of the at least one network node in order to choose one or more operations relating to the performance of the at least one network node, evaluating the machine learning model after performing the one or more operations relating to the performance of the at least one network node, and updating the machine learning model based on the one or more operations.

9. The method of claim 8, wherein the training of the machine learning model comprises:
training the machine learning model by using the received input parameter and a state relating to an environment of the at least one network node to choose one or more actions relating to the performance of the at least one network node; and wherein the updating of the machine learning model based on the one or more operations comprises:
updating the machine learning model based on the one or more operations and based on the state relating to the environment of the at least one network node.

10. A method performed in a network node for handling of machine learning to improve performance of a wireless communications network operating in a wireless communications system, the wireless communications system comprising a central network node and one or more intermediate network nodes arranged between the central network node and one or more leaf network nodes operating in the wireless communications network, the network node is being any one out of the central network node, the one or more intermediate network nodes, or the one or more leaf network nodes, the network node comprising a machine learning unit, the method comprising:
by means of the machine learning unit and a machine learning model relating to at least one network node out of the one or more intermediate network nodes or the one or more leaf network nodes, determining a prediction of a performance of the at least one network node based on input data relating to the at least one network node;
based on the determined prediction, performing one or more operations relating to the at least one network node; and
transmitting at least one of the determined prediction and information relating to the machine learning model to one or more other network nodes.

11. The method of claim 10, wherein the network node is a radio network node, wherein the method further comprises:
when a leaf network node being a communications device connects to the radio network node, receiving, from the communications device, information relating to one or more objectives of the communications device;
transmitting, to the communications device, a machine learning model suitable for the communications device's one or more objectives;
transmitting, to the communications device, a request to collect data to be used as input data for training of a machine learning model relating to the communications device;
receiving, from the communications device, the collected data;
based on the received collected data, updating the machine learning model suitable for the communications device's one or more objectives; and
transmitting the updated machine learning model to the communications device.

12. The method of claim 10, wherein the network node is a radio network node and wherein a respective first and second leaf network node is a respective first and second communications device connected to radio network node, wherein the method further comprises:
performing a negotiation process when the first and second communications devices have conflicting one or more objectives and updating the respective first and second communications devices' machine learning model based on the result of the negotiation process.

13. The method of claim 10, wherein the determining of the prediction of the performance of the one network node comprises:
obtaining from the at least one network node information relating to one or more performed measurements; and
by means of the machine learning unit, using the information relating to the one or more performed measurements as input data to the machine learning model in order to determine the prediction of the performance of the at least one network node, wherein the prediction is based on output data from the machine learning model.

14. The method of claim 10, further comprising:
evaluating the machine learning model after the performing of the one or more operations relating to the at least one network node based on the determined prediction; and
possibly updating the machine learning model based on the evaluation.

15. (canceled)

16. A wireless communications system for handling of machine learning to improve performance of a wireless communications network configured to operate in the wireless communications system, the wireless communications system is being configured to comprise a central network node and one or more intermediate network nodes arranged between the central network node and one or more leaf network nodes configured to operate in the wireless communications network, at least one out of: the central network node, the one or more intermediate network nodes or the one or more leaf network nodes being configured to comprise a machine learning unit, the system being configured to:
by means of the machine learning unit and a machine learning model relating to at least one network node out of the one or more intermediate network nodes or the one or more leaf network nodes, determine a prediction of a performance of the at least one network node based on input data relating to the at least one network node;
based on the determined prediction, perform one or more operations relating to the at least one network node; and
communicate at least one of the determined prediction and information relating to the machine learning model to one or more other network nodes.

17. The system of claim 16, wherein a leaf network node is a communications device connected to an intermediate network node being a radio network node, wherein the system further is configured to:
by means of the communications device transmit to the radio network node information relating to one or more objectives of the communications device when the communications device connects to the radio network node;
by means of the radio network node transmit to the communications device a machine learning model suitable for the communications device's one or more objectives;
by means of the radio network node, request the communications device to collect data to be used as input data for training of a machine learning model relating to the communications device;
by means of the communications device transmit to the radio network node the collected data; and
by means of the radio network node and based on the collected data, update the machine learning model suitable for the communications device's one or more objectives.

18. The system of claim 16, wherein a respective first and second leaf network node is a respective first and second communications device connected to an intermediate network node being a radio network node, wherein the system further is configured to:
by means of the radio network node, perform a negotiation process when the first and second communications devices have conflicting one or more objectives and updating the respective first and second communications devices' machine learning model based on the result of the negotiation process.

19.-24. (canceled)

25. A network node for handling of machine learning to improve performance of a wireless communications network configured to operate in a wireless communications system, wherein the wireless communications system being configured to comprise a central network node and one or more intermediate network nodes arranged between the central network node and one or more leaf network nodes configured to operate in the wireless communications network, the network node is being any one out of the central network node, the one or more intermediate network nodes, or the one or more leaf network nodes, the network node comprising a machine learning unit, the network node being configured to:
by means of the machine learning unit and a machine learning model relating to at least one network node out of the one or more intermediate network nodes or the one or more leaf network nodes, determine a prediction of a performance of the at least one network node based on input data relating to the at least one network node;
based on the determined prediction, perform one or more operations relating to the at least one network node; and
communicate at least one of the determined prediction and information relating to the machine learning model to one or more other network nodes.

26. The network node of claim 25,
wherein the network node is a radio network node, wherein the network node further is configured to:
receive from the communications device, information relating to one or more objectives of the communications device when a leaf network node being a communications device connects to the radio network node;
transmit, to the communications device, a machine learning model suitable for the communications device's one or more objectives;
transmit, to the communications device, a request to collect data to be used as input data for training of a machine learning model relating to the communications device;
receive, from the communications device, the collected data;
based on the received collected data, update the machine learning model suitable for the communications device's one or more objectives; and
transmit the updated machine learning model to the communications device.

27. The network node of claim 25, wherein the network node is a radio network node and
wherein a respective first and second leaf network node is a respective first and second communications device connected to radio network node, wherein the network node further is configured to:
perform a negotiation process when the first and second communications devices have conflicting one or more objectives and updating the respective first and second communications devices' machine learning model based on the result of the negotiation process.

28.-32. (canceled)
